(19) United States
(12) Patent Application Publication
(10) Pub. No.: US 2026/0094098 A1
(43) Pub. Date: Apr. 2, 2026

(54) SYSTEM AND METHODS FOR FLOOD RISK ASSESSMENT

(71) Applicant: Northeast Ohio Regional Sewer District, Cleveland, OH (US)

(72) Inventor: George Remias, Cleveland, OH (US)

(21) Appl. No.: 19/082,397

(22) Filed: Mar. 18, 2025

Related U.S. Application Data
(60) Provisional application No. 63/701,081, filed on Sep. 30, 2024.

(51) Int. Cl. G06Q 10/0635; G06Q 10/0637

(52) U.S. Cl. CPC G06Q 10/0635; G06Q 10/06375

(57) ABSTRACT

Disclosed are systems and methods to assess flood risk for a geographical area and, more particularly, to systems and methods for performing flood risk analyses based on a plurality of parameters.

### CROSS REFERENCE TO RELATED APPLICATIONS

The application claims priority to U.S. Patent Application No. 63/701,081, filed on Sep. 30, 2024, entitled “SYSTEM AND METHODS FOR FLOOD RISK ASSESSMENT,” which is incorporated herein by reference in its entirety.

### FIELD OF THE INVENTION

The present disclosure relates generally to systems and methods to assess flood risk for a geographical area and, more particularly, to systems and methods for performing flood risk analyses based on a plurality of parameters.

### BACKGROUND

As climate change continues to accelerate so do the occurrence of extreme weather events, including the severity and frequency of heavy rainfall and resulting flooding. Higher regional and global temperatures, for example, cause warmer air and warmer waters (e.g., of oceans, seas, lakes, and other bodies of water), both of which can lead to more precipitation.

Moreover, climate change is altering weather patterns and causing a higher incidence of extreme weather events, including large scale storm events and phenomena like El Niños and La Niñas. Such pattern shifts can result in prolonged periods of wet or dry conditions. Often, these patterns occur in alternating periods of heavy rainfall and drought, which increases the risk of both flash floods and water runoff flooding, as dry, compacted soil resulting from dry conditions is less able to absorb rainfall during wet conditions.

Additionally, these warmer temperature conditions from climate change can cause increased and sudden glacier and snow melt, which can, in turn, increase the flow and level of various bodies of water. As such, climate change can also alter the natural geography of water runoff and floodplains by alternating between increasing and decreasing levels of water, causing erosion, and modifying the established path and flow of rivers and streams.

Furthermore, as cities grow, urbanization can contribute to increased flood risk. More impermeable surfaces, such as roads, buildings, and parking lots, can reduce the ability of the land to absorb rainwater while also contributing to heat retention and absorption in city areas. Urbanization can also impact water runoff by impeding the flow of established flood patterns and can shift natural ecosystems as animals and fauna migrate to undeveloped land.

Practically, in many places, climate change is outpacing the capacity of existing drainage and sewer systems. As cities expand and rainfall becomes heavier, the outdated or undersized stormwater management infrastructure can fall short of needs, leading to flooding that impacts higher density populations. The pattern of increased rainfall overwhelms natural water systems, stormwater infrastructure, and drainage systems, leading to flash floods, urban flooding, and riverine floods. Cities are increasingly vulnerable because traditional infrastructure may not be designed for the larger volumes of water generated by climate change-driven storms.

To this end, there is a need for improved systems and methods for assessing flood risk, for example, in city areas. There is a need for flood risk analysis that takes into consideration one or more (or all) of the following: historical rainfall and storm events, predictions of rainfall and storm events based on historical data, predictions of rainfall and storm events based on adjusted historical data due to climate change, city and geographical landscape including structures and development thereof, as well as condition and type of structures, established water runoff and accumulation in particular areas, current sewer and drainage systems, population, and the like.

There is a need for flood risk analysis that can be used to predict one or more (or all) of the following: capacity of current sewer and drainage systems, criticality ratings of city structures and development thereof, mitigation of flood risk based on improvement to sewer and drainage systems, priorities of improvement to sewer and drainage systems based on need and return (e.g., amount of resources compared to impact), and the like.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure. Any of the described aspects may be isolated or combined with other described aspects without limitation to the same effect as if they had been described separately and in every possible combination explicitly.

Disclosed are systems and methods to assess flood risk for a geographical area and, more particularly, to systems and methods for performing flood risk analyses based on a plurality of parameters. Disclosed are systems and methods for assessing flood risk, for example, in city areas. The analysis may take into consideration one or more (or all) of the following: historical rainfall and storm events, predictions of rainfall and storm events based on historical data, predictions of rainfall and storm events based on adjusted historical data due to climate change, city and geographical landscape including structures and development thereof, as well as condition and type of structures, established water runoff and accumulation in particular areas, current sewer and drainage systems, population, and the like. The analysis may be used to predict one or more (or all) of the following: capacity of current sewer and drainage systems, criticality ratings of city structures and development thereof, mitigation of flood risk based on improvement to sewer and drainage systems, priorities of improvement to sewer and drainage systems based on need and return (e.g., amount of resources compared to impact), and the like.

Disclosed is a method of assessing flood risk. In an embodiment, the method may comprise selecting a geographical region. In an embodiment, the method may comprise assigning each asset in the geographical region a condition rating [CR]. In an embodiment, the method may comprise assigning each asset in the geographical region a criticality value. In an embodiment, the method may comprise calculating business risk exposure [BRE] as a product of the condition rating [CR] and the criticality for each asset. In an embodiment, the method may comprise calculating risk [RISK] by subtracting an acceptable level of risk [ALR] value from the business risk exposure [BRE]. In an embodiment, the method may comprise selecting a data set and a climate condition to establish a probable annual frequency [PAF] of a selected storm in the geographical region. In an embodiment, the method may comprise calculating a probable annual risk [PAR] by multiplying the risk [RISK] by the probable annual frequency [PAF].

In an embodiment, the condition rating for each asset may indicate a maximum permissible inundation depth of rainfall before the asset becomes compromised as impassable, inaccessible, or damaged. In an embodiment, the maximum permissible inundation depth of rainfall may be a value between 0 to 50 inches above a freeboard depth of the asset. It is further noted that the maximum permissible inundation depth of rainfall may be any of the following ranges or values within the ranges, including: 0 to 100 inches, 0 to 40 inches, 0 to 30 inches, 0 to 20 inches, up to 5 inches, up to 10 inches, up to 15 inches, up to 20 inches, etc., including all values and ranges therebetween. In an embodiment, the condition rating may be a value selected from 1 to 5. In an embodiment, the higher the condition rating, the lower the maximum permissible inundation depth of rainfall before the asset becomes compromised as impassable, inaccessible, or damaged.

In an embodiment, the condition rating for each asset may indicate a current physical condition of the asset, wherein the current physical condition is defined as status of the asset, age of the asset, or life expectancy remaining of the asset before maintenance, repair, or replacement. In an embodiment, the condition rating may be a value selected from 1 to 5. In an embodiment, the higher the condition rating, the worse the current physical condition of the asset.

In an embodiment, the criticality value for each asset may be based on a type of the asset. In an embodiment, hospitals and critical roadways may be evaluated at a higher criticality than non-essential assets, assets having less financial impact, population or traffic, or recreational assets. In an embodiment, the criticality value may be a value selected from 1 to 9. In an embodiment, the higher the criticality value, the more critical and priority of the asset.

In an embodiment, the acceptable level of risk [ALR] value may be a value selected from 0 to 100. It is further noted that the acceptable level of risk [ALR] value may be any of the following ranges or values within the ranges, including: 0 to 150, 0 to 50, 0 to 30, 0 to 20, 0 to 10, etc., including all values and ranges therebetween. In an embodiment, a positive value for [RISK] may be an unacceptable risk level. In an embodiment, a zero or negative value for [RISK] may be an acceptable risk level. In an embodiment, the [RISK] may not change based on the probable annual frequency [PAF].

In an embodiment, the probable annual [PAF] may be based on NOAA Atlas-14 values data sets for selected duration, depth, and time value(s). In an embodiment, the selected duration value(s) may be chosen from one or more of: a 6 month storm, a 1 year storm, a 2 year storm, a 5 year storm, a 10 year storm, a 100 year storm, a 500 year storm, or a 1,000 year storm. In an embodiment, the probable annual [PAF] may be an inverse of the selected duration value(s).

In an embodiment, the selected depth value(s) may be chosen from one or more of: less than 1 inch, 1 inch, 2, inches, 3 inches, 4 inches, 5 inches, 6 inches, 7 inches, or greater than 7 inches. It is further noted that the selected depth value(s) may be any of the following ranges or values within the ranges, including: 0 to 100 inches, 0 to 40 inches, 0 to 30 inches, 0-20 inches, up to 5 inches, up to 10 inches, up to 15 inches, up to 20 inches, up to 24 inches, up to 48 inches, etc., including all values and ranges therebetween.

In an embodiment, the selected time value(s) may be chosen from one or more of: less than 6 hours, 6 hours, 12 hours, 24 hours, 36 hours, 48 hours, or greater than 48 hours. It is further noted that the selected time value(s) may be any of the following ranges or values within the ranges, including: 1 minute to 90 days, 5 minutes to 60 days, less than 60 minutes, 1 to 24 hours, 1 to 7 days, 1 to 52 weeks, over 1 year, etc., including all values and ranges therebetween.

In an embodiment, the probable annual frequency [PAF] may be modified by a percentage value increase or decrease. In an embodiment, the probable annual frequency [PAF] may be modified by a probability distribution factor. In an embodiment, the probability distribution factor may be chosen from one or more of: a uniform distribution, a Huff distribution including each quarter thereof, or a Soil Conservation Service (SCS) distribution including Types I, IA, II, and III.

In an embodiment, the method may further comprise calculating reduced probable annual risk [PARR] by subtracting post-project calculations from pre-project calculations of probable annual risk [PAR].

The following description and the drawings disclose various illustrative aspects. Some improvements and novel aspects may be expressly identified, while others may be apparent from the description and drawings.

### BRIEF DESCRIPTION OF THE DRAWINGS

The present teachings may be better understood by reference to the following detailed description taken in connection with the following illustrations, in which like reference characters refer to like parts throughout, wherein:

FIG. 1 shows an exemplary regional map including predicted inundation areas by design storm (e.g., 1 year, 2 year, 5 year, 10 year, etc., design storms), a stormwater system, and existing city structures in accordance with aspects disclosed herein;

FIGS. 2A-B shows exemplary building and transportation asset condition rating schematics in accordance with aspects disclosed herein;

FIG. 3 shows an exemplary chart for determining business risk exposure as a product of condition rating and criticality in accordance with aspects disclosed herein;

FIG. 4 shows an exemplary chart for determining unacceptable risk as a calculation of acceptable risk subtracted from business risk exposure in accordance with aspects disclosed herein;

FIGS. 5-7 show diagrams for determining probable annual frequency [PAF] based on climate conditions including depth and duration of rainfall to select storm events and identify floods areas in accordance with aspects disclosed herein;

FIG. 8 shows a graph including multiple distribution types having different rates of rainfall for a same cumulative rain total over a 24-hour time period in accordance with aspects disclosed herein;

FIGS. 9-18 show several model runs of areas within a regional map under various storm conditions and the calculations of total risk [RISK] and probable annual risk [PAR] in accordance with aspects disclosed herein;

FIGS. 19A-E show diagrams for comparing the calculated probable annual risk [PAR] and probable annual risk reduced [PARR] for climate conditions based on year (e.g., 2050 climate condition B 10% NOAA and 2100 climate condition D 20% NOAA) for existing or current conditions (pre-project) and projected post-project conditions (and the difference therebetween) in accordance with aspects disclosed herein;

FIG. 20 shows a diagram for visualizing flood risk assessments based on rainfall projections, distributions, and duration in accordance with aspects disclosed herein;

FIG. 21 shows an exemplary decision tree in accordance with aspects disclosed herein;

FIGS. 22A-B show exemplary graphical representations related to unacceptable levels of risk [RISK] including a regression analysis in accordance with aspects disclosed herein;

FIGS. 23A-F show exemplary graphical representations of each calculation step for a time series analysis in accordance with aspects disclosed herein;

FIGS. 24A-B show various systems and methods that may be used to facilitate the described assessments in accordance with aspects disclosed herein; and

FIGS. 25-38 show embodiments of methods for determining probable annual risk for an asset or regional area in accordance with aspects disclosed herein.

The invention may be embodied in several forms without departing from its spirit or essential characteristics. The scope of the invention is defined in the appended claims, rather than in the specific description preceding them. All embodiments that fall within the meaning and range of equivalency of the claims are therefore intended to be embraced by the claims.

### DETAILED DESCRIPTION

Reference will now be made in detail to exemplary embodiments of the present teachings, examples of which are illustrated in the accompanying drawings, wherein like numbered aspects refer to a common feature throughout. It is to be understood that other embodiments may be utilized and structural and functional changes may be made without departing from the respective scope of the present teachings. Moreover, features of the various embodiments may be combined or altered without departing from the scope of the present teachings. As such, the following description is presented by way of illustration only and should not limit in any way the various alternatives and modifications that may be made to the illustrated embodiments and still be within the spirit and scope of the present teachings.

In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

Further, as herein disclosed, the terms “substantially,” “about,” and variations thereof describe features that are equal or approximately equal to a value or characteristic, as desired, reflecting tolerances, conversion factors, rounding off, measurement error, acceptable variation thresholds, and the like. For example, unless context or this disclosure suggests otherwise, the term “substantially” includes values or characteristics that are exact or within 15% of exact (or what is stated), for example within 10% of exact, or within 5% of exact. In another example, unless context or this disclosure suggests otherwise, the term “about” includes values within 0.5 of a degree to 1 degree of exact (or what is stated). It is noted that for ranges described herein, the range may be inclusive of the lower and upper values unless context or this disclosure suggests otherwise. It is noted that ranges may be combined or narrowed unless context or this disclosure suggests otherwise without departing from this disclosure.

With the progression of climate change, the ability to evaluate current city stormwater and sewer infrastructure based on predicted storm variables may be desired in evaluating risk to city structures and priorities of city projects to update or further develop its infrastructure. As described herein, the disclosed systems and methods may be used to identify and monitor problems in city infrastructure through modeling, evaluate and phase alternatives, prioritize projects for stormwater design and construction plans, track improvement to city infrastructure, support urgent storm event planning and field response, assess impacts due to climate change, and/or predict flood risks using measured and forecasted rainfall (e.g., probabilistic modeling).

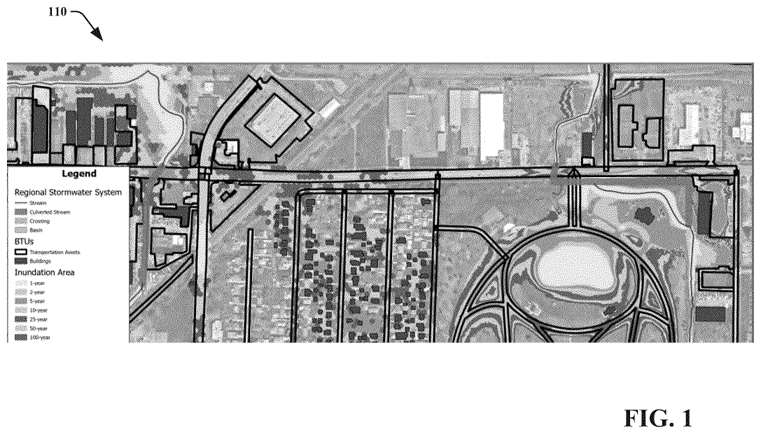

Turning to FIG. 1, shown is an exemplary regional map 110 with gradient overlay. The regional map 110 may depict one or more (or all of): a stormwater system, including sewer and drainage systems as well as existing streams, culverted streams, crossings, and basins. The regional map 110 may further depict one or more (or all of): existing city structures, such as other buildings and transportation assets. As described herein, the regional map 110 can be used to illustrate the calculated probable annual risk and flood assessments for geographical areas.

As described herein, the disclosed systems and methods can be used to identify, assess, model, and forecast flood inundation areas relative the regional map 110 based on, for example, predicted severity and recurrence of design storms (e.g., 1 year, 2 year, 5 year, 10 year, 25 year, 50 year, and 100 year design storms, where a 1 year design storm is typically less severe and occurs more frequently than a 10 year design storm, which is predicted to occur every 10 years and have a greater severity) and rainfall depths and durations, e.g., for 24-hour durations, and by taking into consideration the stormwater system and existing city structures, to provide a comprehensive and city-specific flood risk assessment.

As described herein, the regional map 110 can be used to identify water run-off and accumulation, city infrastructure statuses including drainage and sewer systems, and risk to certain buildings or developed areas, including, for example, how resilient a system is to flooding and the level of service being provided to different areas of the regional map 110. It is noted that inundation depth can include any number of considerations as applicable or desired, including, for example, presence and extent of ground water; natural drainage, water run-off, and accumulation; terrain slope; city drainage, sewer systems, and capacity thereof; city structures affecting water run-off and accumulation such as parking lots, buildings, roads, and the like; condition of local water ways (e.g., rivers, streams, basins, etc.); condition of soil (e.g., dry from drought conditions or wet from wet conditions); and the like.

Generally, the described methods and systems for determining probable annual risk may include several considerations as described herein. For example, in an embodiment, the described methods and systems may comprise calculating business risk exposure [BRE] as a product of condition rating [CR] and criticality, see below equation:

$$Business Risk Exposure [ BRE ] = Condition Rating [ CR ] * Criticality$$

For example, in an embodiment, the described methods and systems may comprise determining unacceptable level of risk [RISK] by subtracting acceptable level of risk [ALR] from the business risk exposure [BRE], see below equation:

$$Unacceptable Level of Risk [ RISK ] = [ BRE ] - Acceptable Level of Risk [ ALR ]$$

For example, in an embodiment, the described methods and systems may comprise determining probable annual frequency [PAF] based on selected climate condition and depth and duration of the climate condition, e.g., based on NOAA data and optional selected percentage additions, see below equation:

$$Probable Annual Frequency [ PAF ] = Climate Condition ( + / - \% )$$

For example, in an embodiment, the described methods and systems may comprise determining probable annual risk [PAR] by multiplying the unacceptable level of risk [RISK] by probable annual frequency [PAF] and optionally by one or more (or a combination of) rainfall distribution factors, see below equations:

$$Probable Annual Risk [ PAR ] = \sum ( [ PAF ] * [ RISK ] )$$

$$[ PAR ] = \sum \{ Probability Distribution Factor [ PDF ] * \sum ( [ PAF ] * [ RISK ] ) \}$$

For example, in an embodiment, the described methods and systems may comprise determining reduced probable annual risk [PARR] by subtracting post-project calculations for probable annual risk [PAR_{(post project)}] from pre-project calculations of probable annual risk [PAR_{(existing)}], see below equation:

$$Probable Annual Risk Reduced [ PARR ] = {PAR}_{( existing )} - {PAR}_{( post project )}$$

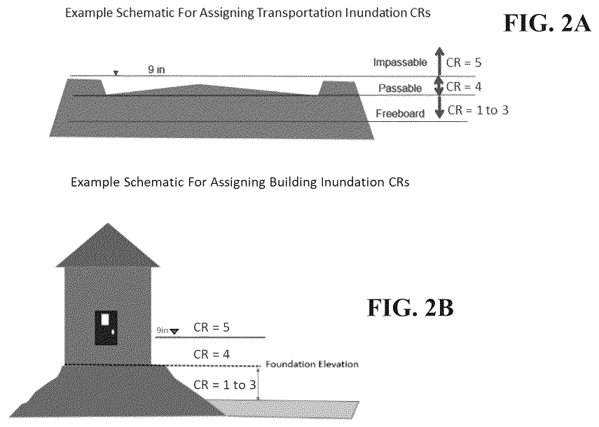

Turning to FIG. 2, shown is an embodiment of condition ratings assessment and application. For example, FIG. 2A shows an exemplary schematic for assessing and assigning transportation inundation condition ratings and FIG. 2B shows an exemplary schematic for assessing and assigning building inundation condition ratings. In an embodiment, condition ratings may be assessed and assigned to each inundated transportation and building asset (e.g., transportation and building assets of interest during flood events that may be inundated during such flood events). In an embodiment, the condition rating may be assessed and assigned based upon the depth of inundation at an inundated building or transportation asset, for example. The assessed and assigned condition ratings may be used during each model run using the disclosed systems and methods for determining probable annual risk and flood assessments for geographical areas. In an embodiment, only the depth of inundation may be considered when assigning condition ratings, for example, and not the size of the storm.

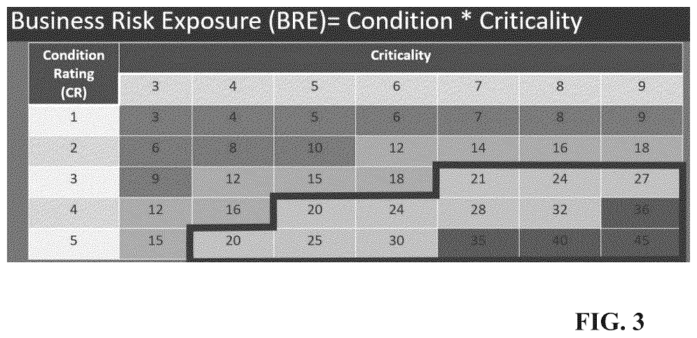

Referring to FIG. 2B, in an example, an inundated depth of 6″ at Building B001 would be assigned a condition rating [CR]=4. If that inundated depth at Building B001 increased to 12″, for example, then the condition rating [CR] assigned to Building B001 would increase from [CR]=4 to [CR]=5. In an embodiment, the same assessment can be applied to transportation assets, for example, following the assigned rules shown in FIG. 2B or FIG. 3, which are based upon inundation depths ([CR] 4 or 5) or freeboard depths ([CR] 1 to 3).

The condition ratings may take into account whether a road is passable or impassable, for example, as well as the foundation elevation of a road or building, freeboard depth of each asset, accessibility or inaccessibility under various inundation depths and conditions, resistance or nonresistance to damage caused by water inundation, and the like. The condition ratings may be understood as a variable of the depth of inundation relative a transportation or building asset.

In an embodiment, each transportation and building asset may have a freeboard depth or value, indicating a vertical distance that may exist before water reaches the transportation and building asset (e.g., a negative depth value). For example, if a transportation and building asset has a sloped design or is on a hill, a certain value of water may be present without affecting the transportation and building asset or causing disruption or damage to the asset. Such freeboard value for each transportation and building asset may be assigned a condition rating of 1 to 3.

In an embodiment, each transportation and building asset may have a threshold depth or value, indicating how much water a structure may be able to encounter, e.g., above the freeboard depth, before becoming impassable, inaccessible, damaged, or the like. For example, a value of 9 inches above the freeboard depth for each transportation and building asset may be used as a threshold. Such values (at or) below 9 inches where the transportation asset is still passable or the building asset still accessible may be assigned a condition rating of 4. Such values (at or) above 9 inches where the transportation asset is impassable or the building asset is not accessible may be assigned a condition rating of 5. Generally, the higher the condition rating, the more severe the inundation relative the transportation or building asset and the lower the condition rating, the less severe the inundation relative the transportation or building asset.

It is noted that 9 inches, for example, may be equivalent to the depth threshold where sedans and other similar vehicles may be impacted (e.g., to be impassable). Other values, such as 16 inches, for example, may be equivalent to the depth threshold where fire engines and other similar emergency vehicles may be impacted (e.g., to be impassable). As a result, the selected inundation depth value may be based on similar factors or other factors, may be selected as a range, may be selected as a universal number, may be selected as an asset-based number, and the like. For example, inundation depth may be based on risk tolerance, threshold depths before assets become impassable, catastrophic levels to determine or assess maximum capacities and tolerance for rain depths, and the like.

In an embodiment, the inundation depth (and resulting condition rating, etc.) as described herein may be based on the peak depth at any moment or, it is noted, that the inundation depth may be variable and based on a time series as further described herein. In an embodiment, the condition rating may be based on depth of rainfall or inundation depths. In an embodiment, the condition rating may be based on depth as a function of velocity, etc. In an embodiment, the condition rating may be based on depth as a function of duration, etc.

In an embodiment, condition rating values may be applied to city structures to reflect the current condition thereof. For example, conditions ratings may reflect whether a structure is new, degraded, in need of repair, and the like. In an embodiment, the better the condition of the city structure, the higher the condition rating may be attributed to the city structure (or vice versa). In an embodiment, structural condition ratings may be assigned based upon an asset's structural integrity. For example, a culverted stream's closed conduit that has several cracks, joint separation, or pipe deflection may receive a higher condition rating because it is more likely to fail. In an embodiment, a condition rating may be assigned to building, transportation, or utility assets that are threatened by open stream erosion. For example, if a streambank is eroding near a building, utility, or transportation asset, and the asset is likely to fail (e.g., fall into the stream), then it may receive a higher condition rating. As herein described, like flood risk, these structural condition ratings are multiplied by the asset's criticality value, and a structural [BRE]/[RISK] is calculated [BRE]=Structural Condition Rating×Asset Criticality value. It is noted that the asset criticality value may be the same criticality value assigned when calculating the BRE due to a flood risk.

As described, a threshold depth of 9-inches may be assigned to both transportation assets and building assets (regardless of criticality), as shown on FIGS. 2A and 2B. It is noted that any threshold depth value or range may be used in the disclosed systems and methods depending on intended application and desired analysis as well as risk tolerance or other factors. It is noted that other inundation or depth values than 9 inches may also be used consistent with this disclosure and depending on the particular assets. It is noted that other condition rating ranges and assessments may also be used consistent with this disclosure, for example, using a scale from 1 through 10 (1-10), 1 through 20 (1-20), etc., as well as attributing a lower or higher tolerance for passability or accessibility, resistance or nonresistance to damage caused by water inundation, and the like. It is further noted that the condition ratings of each asset may be illustrated by other scales, such as a letter scale, color scale, gradient scale, or the like. Further, for example, a user can develop their own rules (e.g., assigning varying [CR] s by asset or asset type), or implement rules that are fixed to provide consistent implementation across many projects and project teams. Similarly, a user can expand the condition rating or criticality values, as needed. For example, the disclosed systems and methods can have assign [CR]=6 for inundation depths=2-feet, or [CR]=7 for inundation depths=4-feet, etc.

As described herein, in an embodiment, condition ratings based on inundation depths and condition ratings based on structure condition may be calculated separately or individually and the summed or added together to provide a [PAR] score.

Turning to FIG. 3, a condition rating may be compared to a criticality of an asset to assess business risk exposure [BRE]. Like condition ratings, criticality values may be applied to city structures based on a tiered or numbered relative ranking systems. For example, highways, local roads, hospitals, fire stations, supermarkets, warehouses, and the like, may be assessed relational criticality values to prioritize importance of each to the area, e.g., compared to the others. In an embodiment, the criticality range can be any range or scale as desired, for example, 1 through 5 (1-5), 1 through 10 (1-10), 1 through 20 (1-20), etc., and can vary based on specific risk tolerances that a city may find permissible. It is further noted that the criticality of a city structure may be illustrated by other scales, such as a letter scale, color scale, or the like.

In an embodiment, the higher the criticality of the city structure, the higher the criticality value may be attributed to the city structure (or vice versa). For example, hospitals and certain roadways may have an assessed value between 9-10 criticality, indicating the highest of the range in a city whereas rural areas without traffic or population may have an assessed value between 1-3 criticality, indicating the lowest of the range in a city. Financial impact may also be used to assess criticality of a structure or asset. The criticality of assets together with the condition rating, can evaluate which structures having higher criticalities are most susceptible to condition ratings of a particular threshold, e.g., specific inundation depths.

The criticality scale and the condition rating scale may have the same values or ranges as each other or may be different (e.g., criticality 1-10 and condition rating 1-10, criticality 1-5 and condition rating 1-10, or vice versa, etc.).

Like inundation depths and condition ratings, other criticality values or ranges may be used in the disclosed systems and methods depending on intended application and desired analysis as well as risk tolerance or other factors. For example, criticality values can be assigned greater than 9 (e.g., criticality=10 or above for assets above a certain economic value, contain a certain population, or have significant cultural value (e.g., Statue of Liberty)). It is noted that any condition rating and/or criticality value or range may be used in the disclosed systems and methods depending on intended application and desired analysis as well as risk tolerance or other factors. So long as the user defines rules for assigning condition ratings or criticality values and follows the rules when implemented into the disclosed systems and methods (and formulas), then the user may not limited to the example 45-point [BRE] matrix or other selected values or ranges for these and similar variables.

As described herein, FIG. 3 shows a chart for calculating business risk exposure [BRE] as a product of condition rating and criticality. Generally, business risk exposure [BRE] ratings can be used to define the structural condition rating of an asset (e.g., the useful life of a concrete pipe, a sewer drain, and the like) to help identify when an asset should receive maintenance, repair, rehab, or replacement, or to define the frequency of follow-up inspections, for example. As described herein, business risk exposure [BRE] ratings may also be applied to portions of a stormwater system (e.g., pipes, drains, headwalls, manholes, portions of detention basins and dams, streams, and the like). Together, the business risk exposure [BRE] ratings accounting for both criticality of structures and condition rating, can provide a value indicating high risk or low risk concerns. For example, business risk exposure [BRE] ratings can quantify comparative risk for degraded sewer systems near a hospital compared to newly replaced systems near undeveloped land, both taking into account current capacity of natural water ways, condition of the soil including from wet or dry conditions, and the like.

In an example, business risk exposure [BRE] ratings may be organized into four tiers (or any number of tiers as may be desired). As shown in FIG. 3, business risk exposure [BRE] ratings less than 12 may be considered low risk, between 12 and less than 20 may be considered moderately low risk, between 20 and less than 34 may be considered moderately high risk, and between 34 and up to 45 may be considered high risk. Such tiers may be given color gradings, e.g., dark green and light green for the lower risk tiers and light red and dark red for the higher risk tiers. The higher risk tiers may generally correspond to structures having a higher criticality and a higher condition rating (e.g., an impassability or inaccessibility at threshold inundation depths or poor conditions such as degradation or damage).

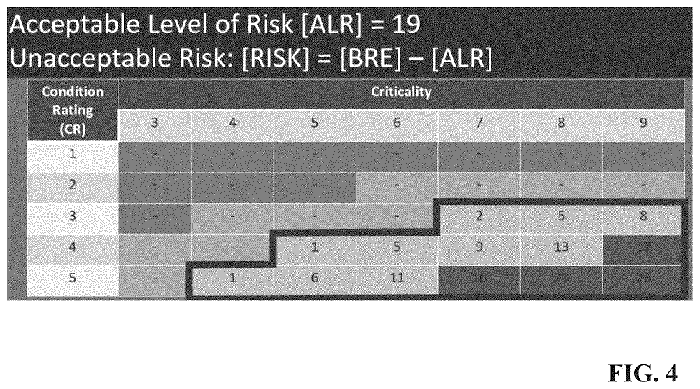

Turning to FIG. 4, the business risk exposure [BRE] ratings may be further compared against acceptable risk [ALR] values and unacceptable risk [RISK] values. For example, if a business risk exposure [BRE] rating for an asset is higher than a value indicating acceptable risk tolerance [ALR] of a system, then the business risk exposure [BRE] rating may reflect a high unacceptable level of risk [RISK]. For example, if a business risk exposure [BRE] rating for an asset is lower than a value indicating acceptable risk tolerance [ALR] of a system, then the business risk exposure [BRE] rating may reflect a low level of risk [RISK] (and, e.g., the unacceptable level of risk [RISK] may be a negative or N/A value indicating little to no level of unacceptable risk [RISK]). In an embodiment, the higher the unacceptable risk [RISK], for example, the greater risk or higher priority for asset intervention may be indicated compared to other assets. In an embodiment, the lower the unacceptable risk [RISK], for example, the lesser risk or lower priority for asset intervention may be indicated compared to other assets. Additionally, negative values for [RISK] could be used to indicate or assess the resistance, resilience, protection, etc. of one or more assets from an unacceptable risk under defined conditions. The negative values for [RISK] may be used to indicate best practices and particularly tolerable landscapes, interventions, or the like, that then may be utilized for and applied to assets or areas having a higher [RISK] value with the intent to lower the [RISK] value.

Generally, unacceptable risk [RISK] may be determined by subtracting acceptable risk [ALR] values from the business risk exposure [BRE] ratings. The level of acceptable risk [ALR] may be any value based on, for example, risk tolerance of a system. As described herein, FIG. 4 shows a chart for determining unacceptable risk [RISK] as a calculation of acceptable risk [ALR] subtracted from business risk exposure [BRE] ratings. In an embodiment, for example, acceptable level of risk [ALR] may be 19. It is noted that other acceptable level of risk [ALR] values than 19 may also be used consistent with this disclosure and depending on the particular desired risk tolerance of the system. As shown in FIG. 4, business risk exposure [BRE] ratings less than 12 may have a zero, less than zero, or N/A unacceptable [RISK] value, business risk exposure [BRE] ratings between 12 and less than 20 may have a zero, less than zero, or N/A unacceptable [RISK] value, business risk exposure [BRE] ratings between 20 and less than 34 may have an unacceptable [RISK] value between 1 to 14, and business risk exposure [BRE] ratings between 34 and up to 45 may have an unacceptable [RISK] value between 15 to 26.

As described herein, the calculated [RISK] values may be further analyzed against probable annual frequencies [PAF] of storms to determine the calculated probable annual risk [PAR]. Generally, it may be desired to have the probable annual risk [PAR] be zero, indicating none or negligible probable annual risk [PAR]. In an embodiment, probable annual risk [PAR] may be calculated either or both for existing conditions and for post-project conditions, e.g., to determine if and to what extent a project (such as replacing part of the city infrastructure drainage or sewer system, or increasing the capacity thereof, improving water run-off direction or accumulation, etc.) may improve or reduce the probable annual risk [PAR] of an area. In an embodiment, probable annual risk [PAR] may be calculated either or both for existing conditions and for post-project conditions, e.g., to determine if and to what extent a project (such as adding to city infrastructure which, inhibiting water run off direction or accumulation) may worsen or further contribute to the probable annual risk [PAR] of an area.

Generally, probable annual frequency [PAF] may represent how often certain rainfall conditions occur, e.g., storm type and frequency, storm type and frequency varied by climate condition, storm type and frequency varied by distribution type, etc. Generally, the calculated [RISK] may represent what assets (including condition and criticality, and therefore priority) are flooding, e.g. flood risk threshold or unacceptable flood risk. In an embodiment, the calculated [RISK] may be constant and may not change based upon the probable annual frequency [PAF].

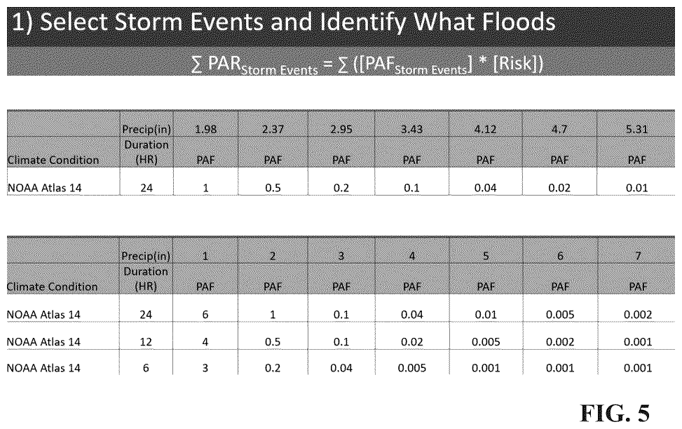

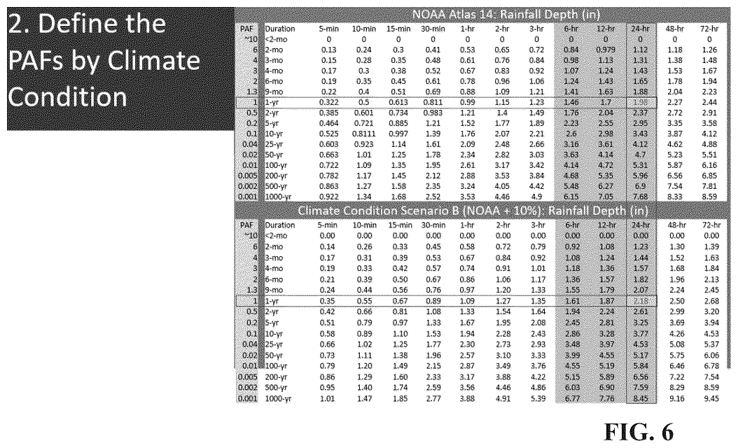

In an embodiment, the probable annual frequency [PAF] may be based on climate conditions including depth and duration of rainfall as well as the likelihood or frequency of storm type, see FIG. 5, for example. In an embodiment, the probable annual frequency [PAF] may be used to select storm events and identify floods areas, and to calculate the probable annual risk [PAR] (e.g., as a step one related to selecting, determining, and/or modifying [PAF]).

In an embodiment, the probable annual frequency [PAF] may be the inverse of a recurrence interval (e.g., for a 10 year design storm, the probable annual frequency [PAF] would be 1/10, for a 50 year design storm the probable annual frequency [PAF] would be 1/50, for a 6 month design storm the probable annual frequency [PAF] would be 2, etc.), see FIG. 6, for example. In an embodiment, the probable annual frequency [PAF] may be based on published data, e.g., from the published atlases, from the NOAA published atlases, other historical rainfall data, and the like. For example, probable annual frequency [PAF] can be based on Atlas 14 values for 1, 2, 5, 10, 25, 50, 100 year, etc., storms and 24 hour rainfall data, and to the depth of rainfall associated with such selected variables, see FIG. 6, for example. As described herein, such [PAF] data may be modified by certain percentage additions or subtraction adjustments and/or with a distribution type, such as an SCS Type II distribution type.

It is noted that other storm events and frequencies may be used, including for example, 15 year storms, 150 year storms, 500 year storms, 1,000 year storms, etc., and the like. It is noted that other storm events and duration may be used, including for example, 6 hour rainfall data, 12 hour rainfall data, 36 hour rainfall data, 48 hour rainfall data, etc., and the like. As described herein, any and other storm events and distribution types may be used, including for example, HUFF distribution types and quarter breakdowns thereof, uniform distribution types, etc., and the like. As described herein, adjustments including percentage increases or decreases from 0-100% may be added to or subtracted from the data used for probable annual frequency [PAF] and that probable annual frequency [PAF] may be multiplied or divided by any factor, e.g. by 0.5, 2, 3, 4, etc., and the like. Any of the foregoing variables and values may be adjusted depending on intended application and desired analysis.

Although NOAA and Atlas-14 values are described herein, it is noted that any subset of data, including actual, historical, predicted, or forecast data, models, etc., to reflect likelihood and frequency of certain intensity storms may be utilized with the disclosed methods and systems. It is also noted that data related to other weather events may be used with the disclosed methods and systems to predict probable annual risk [PAR] for that type of weather event for a geographical area. For example, the disclosed methods and systems may also be used to assess probable annual risk [PAR] for hurricanes, tornadoes, droughts, wildfires, earthquakes, wind speed, temperature, snow and blizzards, avalanches, storm surge, tsunamis, and the like.

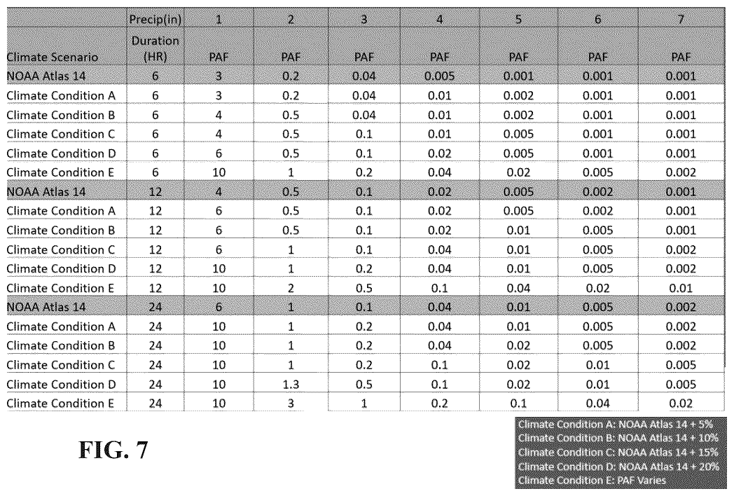

In an embodiment, the probable annual frequency [PAF] may correspond to climate conditions, for example, how often a storm is predicted occur, how much rainfall is predicted to occur including depth and duration analysis, each of the foregoing taking into account climate change increases in frequency and accumulation, and the like. Such variable may be referred to as the probable annual frequency [PAF] varied by rainfall depth/duration for climate condition (x) depth/duration. In an embodiment, the probable annual frequency [PAF] may be defined by one or more climate conditions and used to calculate the probable annual risk [PAR] (e.g., as a step two related to selecting, determining, and/or modifying [PAF]). For example, a first climate condition may comprise the NOAA data +20%. Other climate conditions may include NOAA data +5%, +10%, +15%, +25%, 0%, −5%, −10%, −15%, −20%, −25%, etc., see FIGS. 6-7, for example, illustrating several NOAA data sets comparing rainfall depth at certain time intervals for various duration storms (e.g., 6-month, 1 year, 2 year, 5 year, 10, year, 100 year, etc., storms), the corresponding inverse probable annual frequency [PAF] value (e.g., 2, 1, 0.5, 0.2, 0.1, 0.01, etc., probable annual frequency [PAF] values), and adjustments to the NOAA values including 5%, +10%, 15%, 20%, and variable probable annual frequency [PAF]. It is noted that any other percentages for climate conditions may also be used consistent with this disclosure and depending on the intended application and desired analysis. Additionally, variable probable annual frequency [PAF] value may be used where the data sets are adjusted by a certain percentage value for a subset of the data and a different percentage value for another subset of the date (e.g., +5% for the first half of data and 10% for the second half of data, etc.).

In an embodiment, such additional percentages may be used to account for predicted climate change, may be used to assess limits of city infrastructure, may be used for lower risk tolerance thresholds (in the case of a percentage added) or higher risk tolerance thresholds (in the case of a percentage subtracted), to provide an improved system resistant to more sever weather and rainfall events, and the like. Any percentage values may be added or subtracted from the data to provide a custom probable annual frequency [PAF] depending on intended application and desired analysis. In an embodiment, the probable annual frequency [PAF] may be used to select storm events and identify floods areas, and to calculate the probable annual risk [PAR].

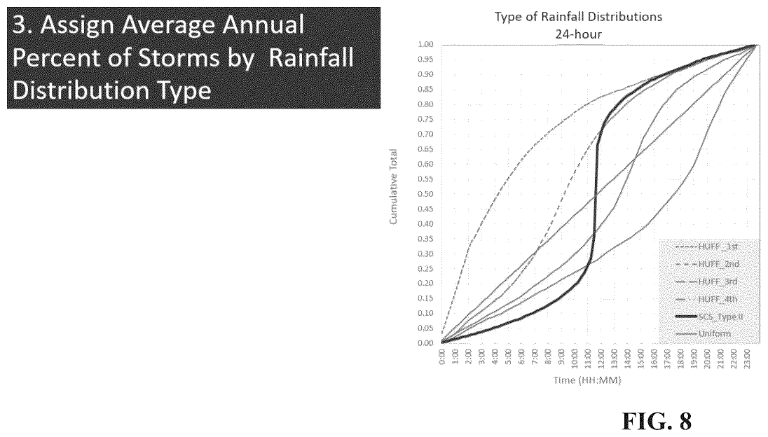

In an embodiment, the probable annual frequency [PAF] or probable annual risk [PAR] may be adapted based on a probability distribution factor [PDF], see FIG. 8, for example, illustrating several possible distribution types for accumulation of 1 inch of rainfall over a 24-hour time period. In an embodiment, the probable annual frequency [PAF] may be defined by one or more distribution types and used to calculate the probable annual risk [PAR] (e.g., as a step three related to selecting, determining, and/or modifying [PAF]). For example, the distribution of an amount of rainfall over a certain period or time (e.g., over the same depth and duration) may have several possibilities related to the rate or distribution type. In an embodiment, the probability distribution factor [PDF] may be uniform, e.g., having the same rate of rainfall over time. In an embodiment, the probability distribution factor [PDF] may be variable or non-uniform. In an embodiment, the probability distribution factor [PDF] may follow a Huff distribution, including Huff 1^{st} quarter, 2^{nd} quarter, 3^{rd} quarter, 4^{th} quarter, 1^{st} half, 2^{nd} half, whole Huff distribution, and the like. In an embodiment, the probability distribution factor [PDF] may follow a Soil Conservation Service (SCS) distribution curve, including any or all of Type I, Type IA, Type II, and Type III distribution curves. It is noted that any other distribution curves, probability distributions, and the like, including those not specifically related to rainfall, may also be used consistent with this disclosure and depending on the intended application and desired analysis. It is further noted that while the probability distributions are noted, other distributions such as those based on actual, predicted, adjusted, etc., data may also be used.

In an example, the probability distribution may be equal 1.0, which may be the intended assigned value of that variable (e.g., what is the probable percent of all the rainfall events that are expected to have that type of rainfall distribution (e.g., Huff 1st quarter)). For finite probability spaces (e.g., a discrete number of storm events), a table listing the probability distribution (that all add up to 1.0) may be used. In an embodiment, assigning the probability of an event (e.g., P(A)=sum of the probabilities of the events in A=sum of p table of discrete values that add up to 1.0 can be referred to as a “probability distribution” or “probable distribution.”

In an embodiment, different distribution types or subset of distribution type may be applied to the probable annual risk [PAR] analysis and calculation. Generally, assigning average annual percent of storms by rainfall distribution type may include analysis of historical rainfall storm events, assessment of average percentage of historical storms by rainfall distribution type, and adjustments to percentage of higher intensity rainfall distributions to future storms. For example, historical data for an area may be used to determine likelihood of the occurrence of distribution types or subset of distribution type. For example, it may be realized that for a particular regional area, a 1^{st} quarter Huff distribution may be likely based on historical data and/or predictive data. In an embodiment, the distribution types or subset of distribution type may be determined based on percent of events with this distribution type or subset of distribution types. In an embodiment, custom distribution types may also be developed based on historical data and/or predictive data of the region. This distribution may be applied to the probable annual risk [PAR] analysis and calculation by multiplying by the probability distribution factor [PDF].

Like variable probable annual frequency [PAF] values described herein, variable probability distribution factor [PDF] values may similarly be used where the data sets are adjusted by a certain distribution factor for a subset of the data and a different distribution factor for another subset of the date (e.g., uniform for the first half of data and SCS Type II for the second half of data, etc.). In an embodiment, the probability distribution factor [PDF] can be further modified to incorporate multiple probability distribution factors [PDF] and divided into percentages of more than one probability distribution factor [PDF]. For example, if determined that a probable percent of storms with a rainfall distribution are 0.4 or 40% SCS Type II, this may be incorporated into the determination of probable annual risk [PAR] as the probability distribution factor [PDF]. Moreover, if determined that a probable percent of storms with a rainfall distribution are also 0.1 or 10% uniform and 0.5 or 50% Huff 2nd quarter, these may incorporated into the determination of probable annual risk [PAR] as a summation of the probability distribution factor [PDF].

It is noted that the summation of each component probability distribution factor [PDF] may equal 1 so that each component probability distribution factor [PDF] operates a fraction of the total or sum probability distribution factor [PDF] used to calculate probable annual risk [PAR]. Generally, the probability distribution factor [PDF] may represent rainfall distribution. Generally, the probability distribution factor [PDF] may represent how intense certain rainfall may be, e.g., storm type, depth, duration, and frequency over a specific time frame or as a function of rate, etc.

Together, for the selected rainfall depth durations (i), by applying the combined percentage (y) of storms assigned to each rainfall distribution (j) under climate condition (x) to the probable annual risk [PAR] score of each model-predicted flood risk asset yields the total probable annual risk [PAR_{Total}] as:

$$[ {PAR}_{Totalxy} ] = \sum \{ [ {PDR}_{( RDy ) j} ] * ( \sum ( [ {PAF}_{( x ) Depth / Durationi} ] * [ {RISK}_{assetsij} ] ) ) \}$$

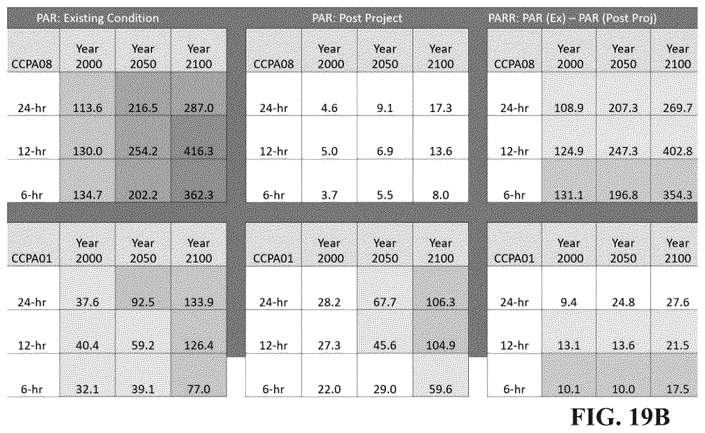

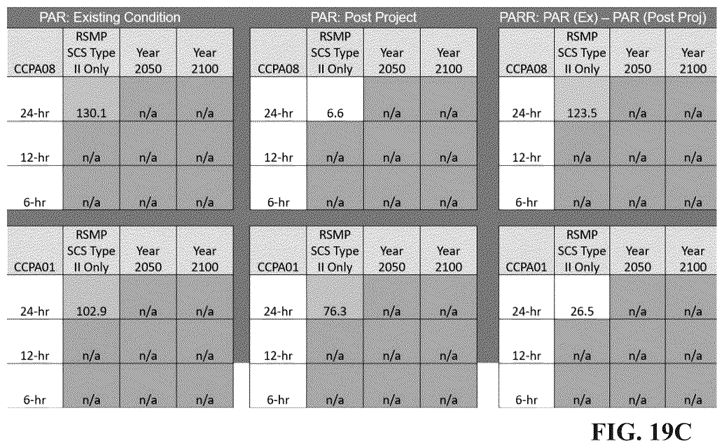

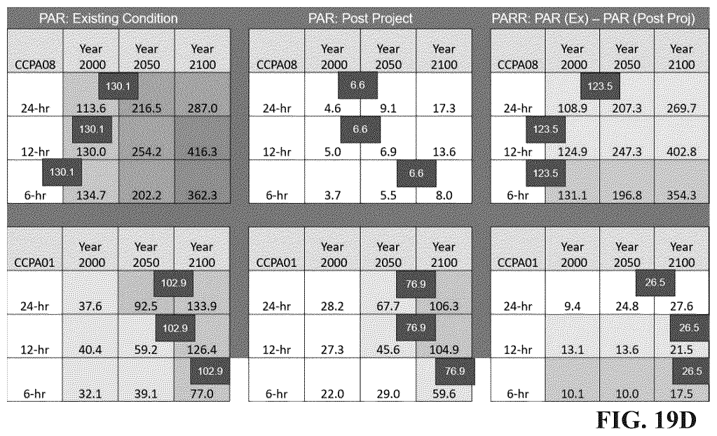

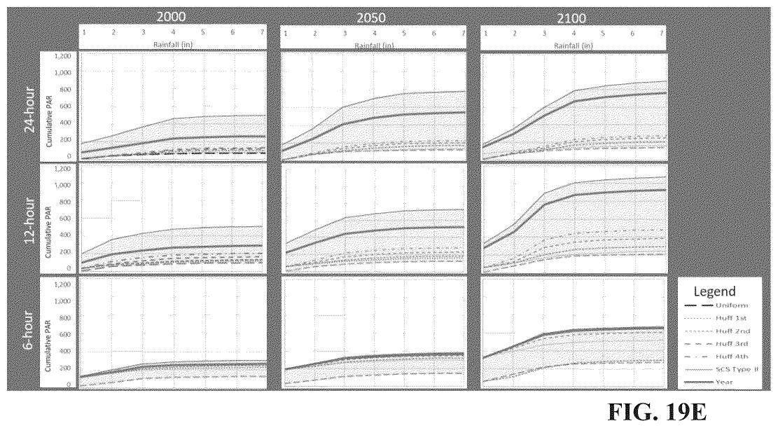

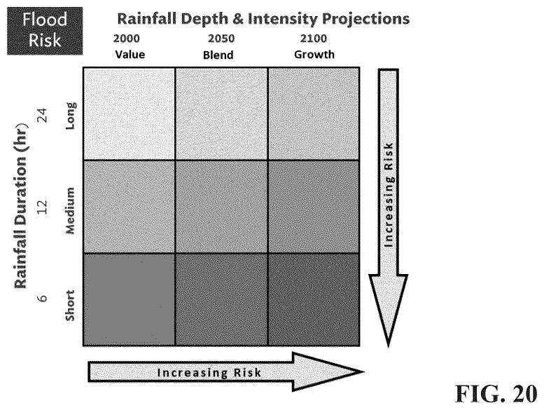

In an embodiment, all rainfall depth durations can be model simulated to calculate the respective [RISK] of each event. In an embodiment, the described methods and systems can include defining the [PAF] for each event. In an embodiment, the described methods and systems can include calculating the corresponding [PAR] score for each event. In an embodiment, the described methods and systems can include calculating the total [PAR] score (e.g., summing the collection of events for a particular duration). For example, the total [PAR] for the 1, 2, 5, 10, 25, 50, and 100-year 24-hour storm that have a Huff 1st quarter distribution can be summed. For example, the probability of that Huff 1st quarter distribution for that duration can be multiplied by the total [PAR] score for the Huff 1st quarter. In an embodiment, the same steps may be executed for the remaining rainfall distributions to assign the total [PAR] score for a particular climate condition with a particular duration that accounts for all probable rainfall distributions. In an embodiment, the same logic may be repeated for each duration and climate condition. The [PAR] flood matrix shown in FIG. 20 or the example from FIG. 19B show an exemplary end result (e.g., one [PAR] score).

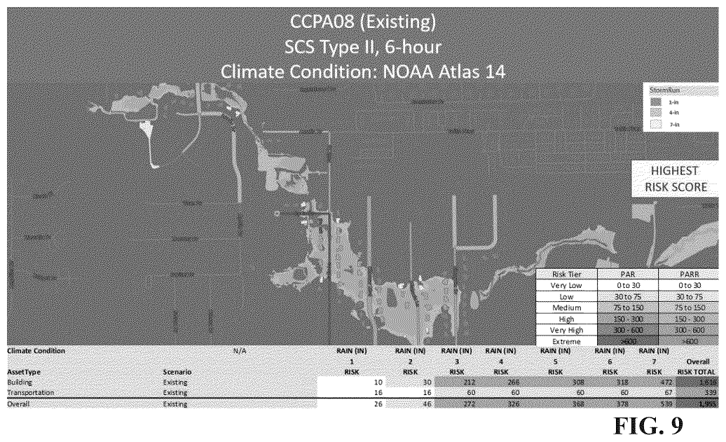

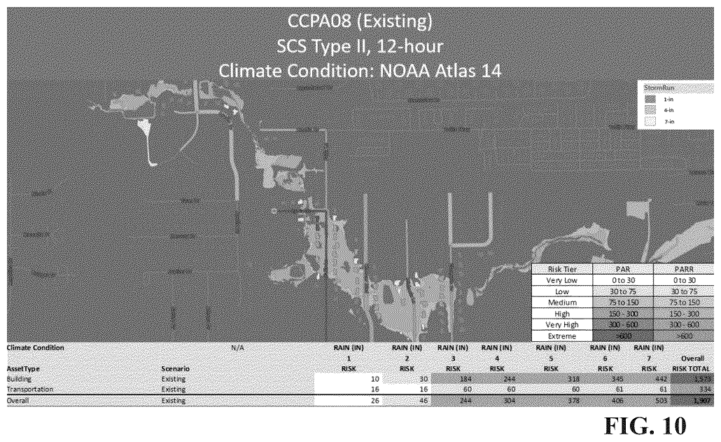

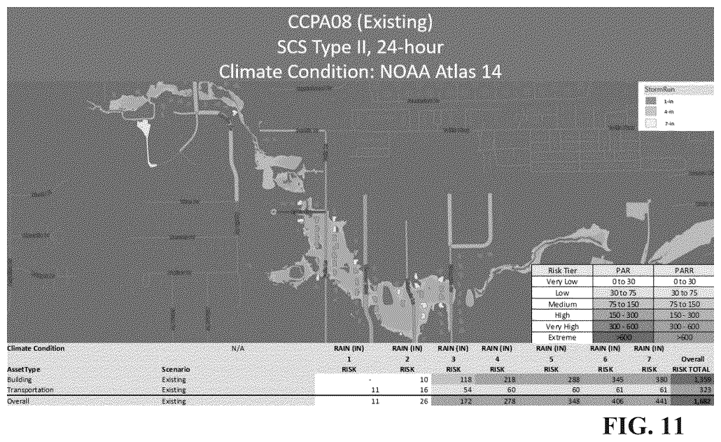

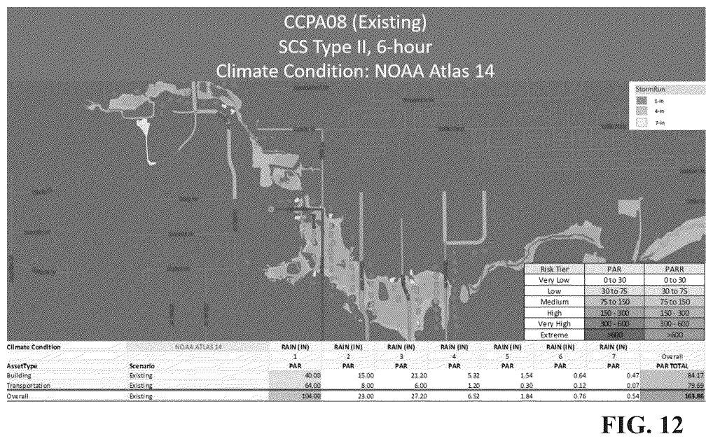

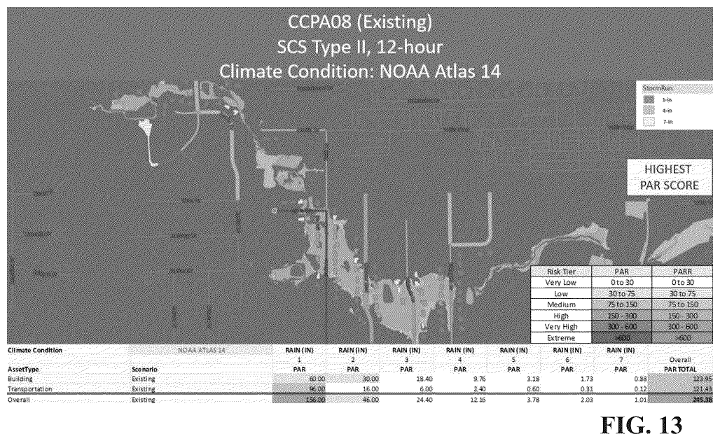

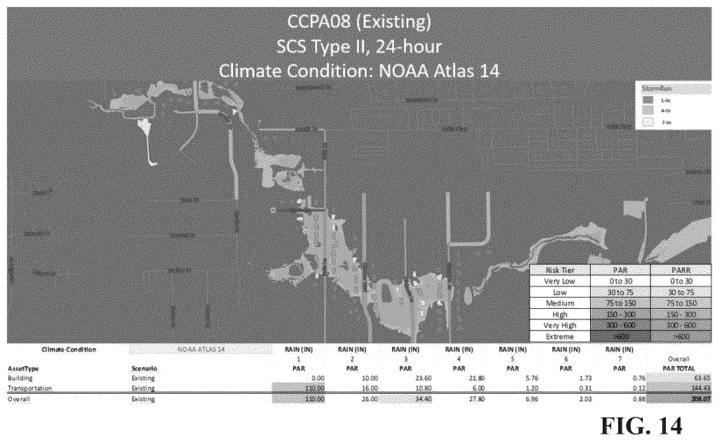

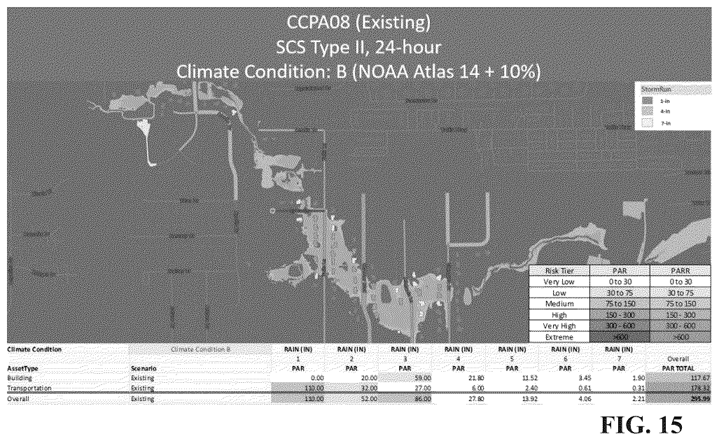

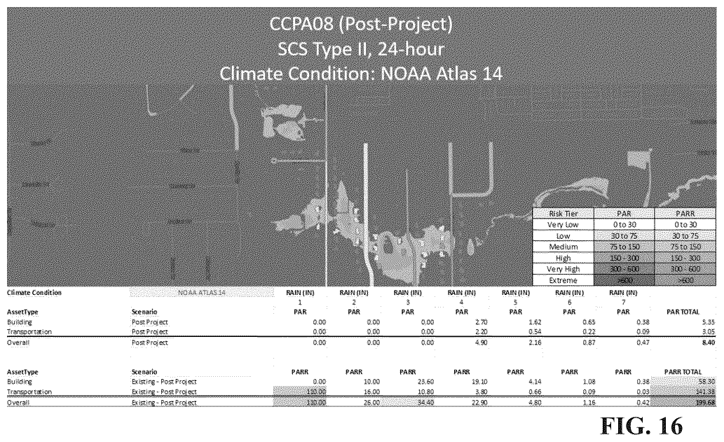

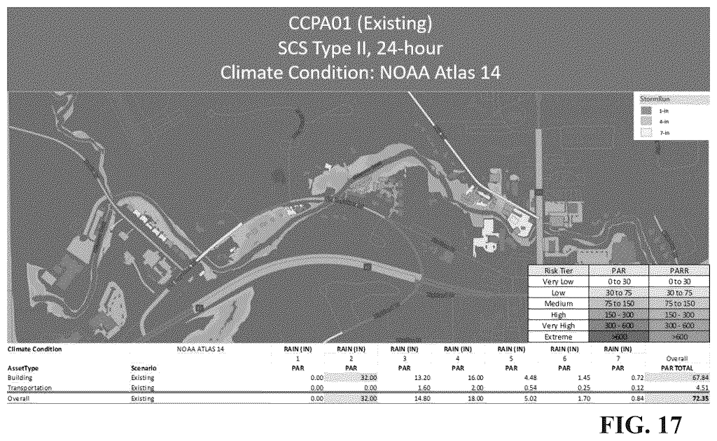

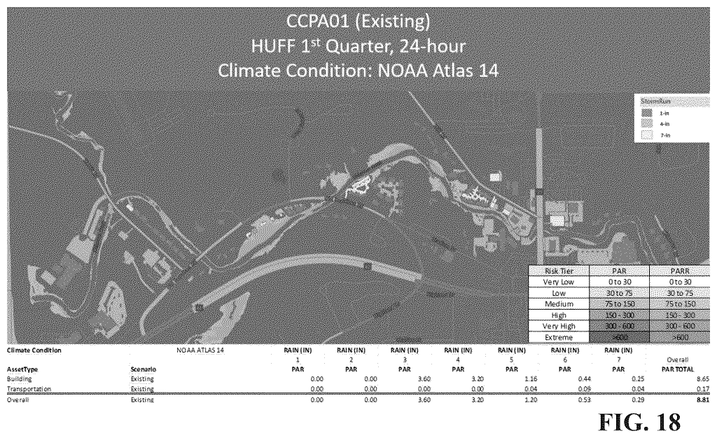

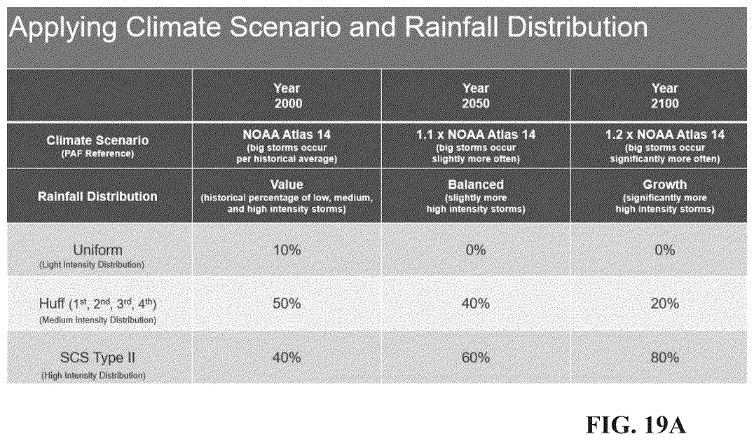

FIGS. 9-18 show various model runs of a region and the calculations of total risk and probable annual risk. The model runs as shown may be based on several factors including depth and duration of a storm, selected climate conditions, and distribution types as described herein. For example, the model runs may include seven rainfall depths (1, 2, 3, 4, 5, 6, 7-in), three rainfall durations (6, 12, 24-hr), six rainfall distribution types (uniform, Huff 1st, Huff 2nd, Huff 3rd, Huff 4th, SCS Type II), and two stormwater infrastructure conditions (existing, post recommended project). It is noted that other depths and durations of a storm, selected climate conditions, and distribution types may also be used consistent with this disclosure and depending on the intended application and desired analysis. The region of interest further includes hundreds of transportation and building assets evaluated, including corresponding condition ratings [CR] and criticality assigned values to calculate risk tolerance [RISK].

The model runs further include [PAR] scores calculated for both existing conditions and for post-project conditions, which can further indicate projected value in project by decreasing the risk and [PAR] score associated with an asset or region. FIGS. 19A-E, for example, show diagrams for comparing the calculated probable annual risk [PAR] for existing or current conditions (pre-project) and projected post-project conditions (and the difference therebetween).

For example, FIG. 19A describes the probable distribution of the rainfall distribution types for each climate scenario (e.g., Year 2000, Year 2050, Year 2100). As described herein, FIG. 7 lists the [PAF] used under each climate scenario for the precipitation events.

For example, FIG. 19B shows examples for [PAFs] and probable distribution tables that were used for the Year 2000, Year 2050, and Year 2100. For example, for the year 2000: the [PAFs] are based upon climate scenario NOAA Atlas 14 listed in FIG. 7; and the probability distribution for uniform, Huff (equally distributed between 1st, 2nd, 3rd, and 4th quarter), and SCS type II distributions are listed under Year 2000 of FIG. 19A. For example, for the year 2050: the [PAFs] are based upon climate scenario Climate Condition B listed in FIG. 7; and the probability distribution for uniform, Huff (equally distributed between 1st, 2nd, 3rd, and 4th quarter), and SCS type II distributions are listed under Year 2050 of FIG. 19A. For example, for the year 2050: the [PAFs] are based upon climate scenario Climate Condition D listed in FIG. 7; and the probability distribution for uniform, Huff (equally distributed between 1st, 2nd, 3rd, and 4th quarter), and SCS type II distributions are listed under Year 2100 of FIG. 19A.

Turning to FIG. 19C, shown is the corresponding [PAR] score using the assumptions applied under RSMP (SCS Type II only and NOAA Atlas 14 [PAFs]). The [PAFs] are based upon NOAA Atlas 14 24-hour distribution only. The probable distribution=1.0 for SCS Type II. In an embodiment, this is the only type of rainfall distribution applied, but it is noted that the disclosed methods and systems may include embodiments that do include evaluating uniform or Huff distributions when defining problems or evaluating alternatives. FIG. 19D simply shows the [PAR] score from FIG. 19C (following the RSMP [PAF] and probable rainfall distribution) overlapping the [PAR] scores from FIG. 19B to compare how the method (using the flood risk matrix) lines up compare to the other flood risk scores.

FIG. 20 show diagrams for visualizing flood risk assessments based on rainfall projections, distributions, and duration. For example, a box diagram may be used to compare rainfall distribution over different subsets of time (e.g., 6, 12, 24, etc. hours) to climate scenarios based on design storm and selected variable vales (e.g., NOAA Atlas 14, percentage adjustments, rainfall distribution type, etc.), see also FIG. 19A.

As described herein, the disclosed methods and systems related to determining the probable annual risk [PAR] for certain flood events of a particular geographical area and under selected conditions may further include one or more (or all) of: expanding the range of rainfall depth, expanding the range of rainfall duration, and varying the rainfall distribution type. As described herein, the disclosed methods and systems may further be used to assess flood risk resiliency to climate change by varying the probable annual frequency [PAF] of each storm event to potential future climate conditions and/or comparing probable annual risk [PAR] scores to NOAA Atlas 14, or other data values.

The disclosed systems and methods described herein may further comprise machine learning and/or artificial intelligence. In an embodiment, the disclosed systems and methods may include one or more (or all) of the following steps: collect and identify storm events of interest and measured data (e.g., peak water level); calculate rainfall statistics for storm events of interest (e.g., peak 5-minute rainfall, peak 1-hour rainfall); estimate corresponding flood risk [RISK] by storm event; format rainfall statistics and corresponding [RISK] by storm event; and utilize machine learning and/or artificial intelligence (MLAI) to identify MLAI techniques and corresponding rules regarding the probabilities of [RISK] by rainfall. It is noted that such embodiments may include all preceding steps in the order as written, one or more of the preceding steps in the order as written, all the preceding steps in a different order than written or one or more of the preceding steps in a different order than written, and the like. It is noted that other steps may also be included without departing from the scope of this disclosure or that the preceding steps may include all the steps for a particular embodiment of the disclosed systems and methods.

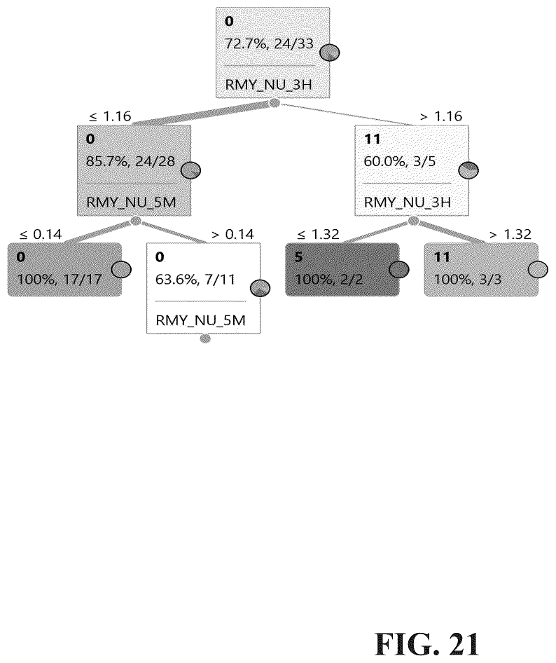

Turning to FIG. 21, for example, shown is an exemplary decision tree. As described herein, the decision tree may incorporate machine learning and/or artificial intelligence. It is also noted that the decision tree may be utilized without machine learning and/or artificial intelligence. In an embodiment, the decision tree may include inputs for a particular geographical area to be assessed for flood risk. In an embodiment, the decision tree may include sample data, actual data (e.g., from rain gauges, etc.), current or historical data, predictive data, adjusted data, and the like. In an embodiment, the decision tree may include inputs for varying rainfall accumulation and determination of risk thereof. For example, the decision tree can be used to assess and indicate the probability that an unacceptable level of [RISK] may occur under different rainfall conditions for a selected geographical region. Generally, the bold numerical values shown in the decision trees may represent the [RISK] score and indicate, e.g., the probability or likelihood that this [RISK] score will occur.

In the first box of the decision tree, for example, the 0 value indicates [RISK] such that of the 33 rainfall events provided (e.g., from one or more types of data) there is a 72.7% probability that the [RISK] score is equal to 0 (e.g., no flood risk). In the first box of the second row of the decision tree, for example, there is an 85.7% probability that the [RISK] is 0 if the peak 3-hour rainfall amount from the selected geographical region is less than or equal to 1.16-inches. In the second box of the second row of the decision tree, for example, there is an 60.0% probability that the [RISK] is 11 if the peak 3-hour rainfall amount from the selected geographical region is greater than 1.16-inches. Further, the probability of the [RISK] equaling 11 increases from 60.0% to 100.0% probability if the peak 3-hour rainfall amount from the selected geographical region is greater than 1.32-inches. Otherwise, there is a 100.0% probability the [RISK] equals 5 if the peak 3-hour rainfall amount from the selected geographical region is less than or equal to 1.32-inches.

In an embodiment, the [RISK] score may be indicated for a singular selected asset. In an embodiment, the % may indicate the probability of a particular outcome. In an embodiment, a smaller number may indicate less risk or severity of a rain event. In an embodiment, colors may be used to indicate passability or risk to an asset. For example, red may indicate that an asset, such as a road, may be impassable under the given conditions for time duration/rainfall accumulation. For example, green may indicate that an asset, such as a road, may be passable under the given conditions for time duration/rainfall accumulation.

The disclosed systems and methods described herein may further comprise statistical methods and/or regression analysis. In an embodiment, the disclosed systems and methods may include one or more (or all) of the following steps: run storm events over the course of a year and calculate [RISK]; summarize the total [RISK] per year; and conduct regression analysis to estimate Probable Annual Risk [PAR] using RISK per year (1-yr, 2-yr, 5-yr [PAR], 10-yr [PAR], etc.). In an embodiment, the disclosed systems and methods may include one or more (or all) of the following steps: calculate and identify [RISK] per year (e.g., cumulative, annual maximum, partial duration, etc.); calculate mean and standard deviation of [RISK] (e.g., standard, log normal, etc.); estimate the [RISK] by recurrence interval; and convert [RISK] to [PAR] by dividing [RISK] by the Recurrence Interval, see below equation:

$$[ PAR ] = [ RISK ] / Recurrence Interval ( yr )$$

It is noted that such embodiments may include all preceding steps in the order as written, one or more of the preceding steps in the order as written, all the preceding steps in a different order than written or one or more of the preceding steps in a different order than written, and the like. It is noted that other steps may also be included without departing from the scope of this disclosure or that the preceding steps may include all the steps for a particular embodiment of the disclosed systems and methods.

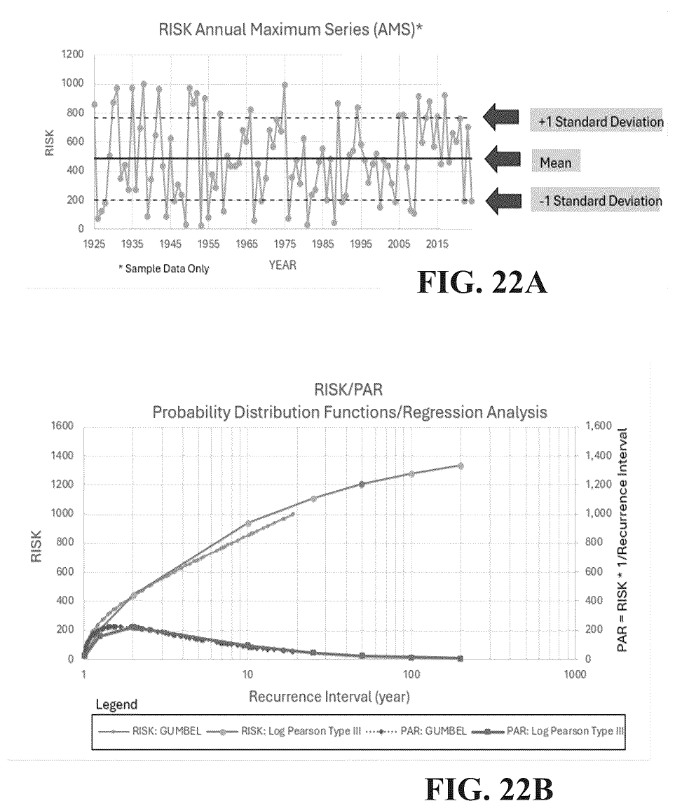

Turning to FIG. 22A-B, for example, shown are graphical representations of the [RISK] annual maximum series as a function of [RISK] over year and further showing indications for mean and +1 standard deviation and −1 standard deviation, in FIG. 22A, and of the [RISK]/[PAR] probability distribution functions and regression analysis as a function of [RISK] over recurrence interval (year), in FIG. 22B. In an embodiment, the described systems and methods may use sample data to conduct a GUMBEL and Log Pearson Type III statistical analysis. It is noted that other sample data, actual data, current or historical data, predictive data, adjusted data, and the like may also be used with the described analyses and that different statistical analyses may additionally be used as may be desired or suitable for a particular application without departing from the disclosure. In an embodiment, the risk regression analysis may utilize whole series of storms over a time period, e.g., over a year where out of 100 storm events, X value may have risk associated therewith. In an embodiment, the risk regression analysis may sort or rank the storms in the series over a time period based on severity. In an embodiment, the risk regression analysis may utilize actual data rather than synthetic design storms. In an embodiment, the risk regression analysis may utilize actual distribution data rather than distribution classifications.

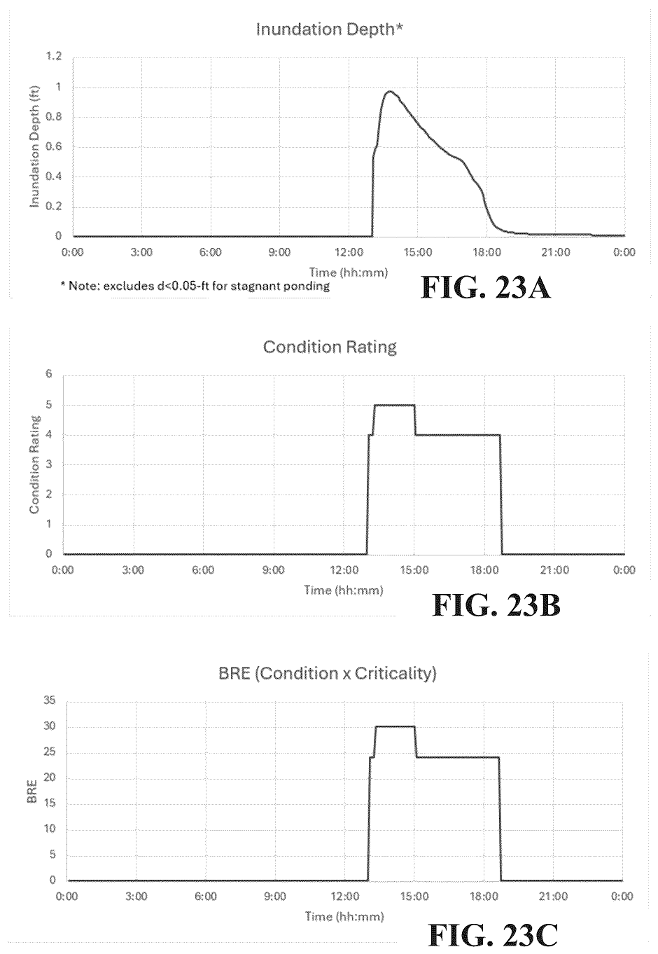

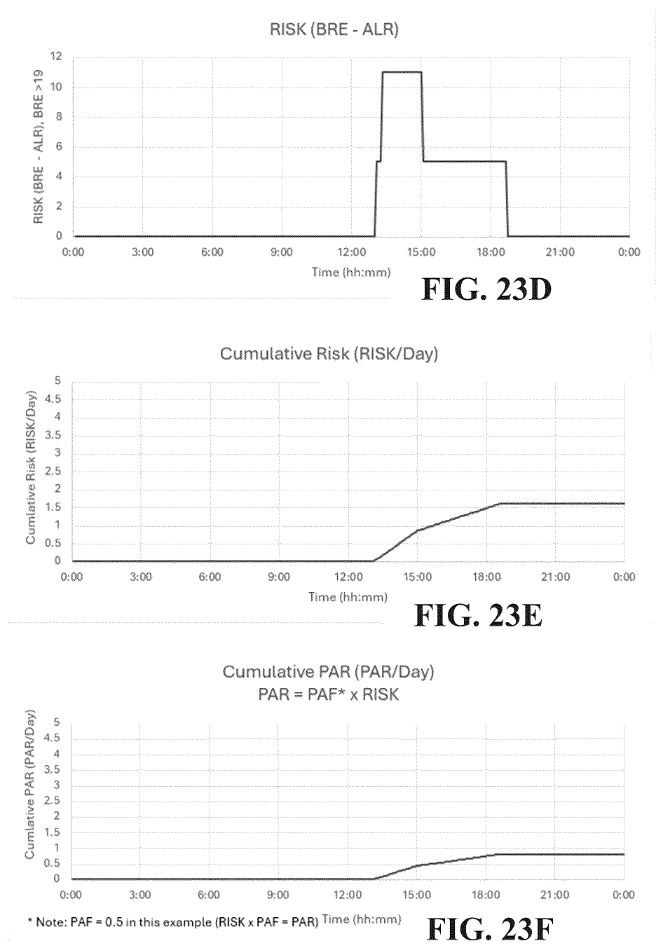

The disclosed systems and methods described herein may further comprise a time series analysis. In an embodiment, the disclosed systems and methods may include one or more (or all) of the following steps: create inundation depth [ID] time series for a flood risk asset of interest (e.g., per stormwater model runs or monitoring data, for example); convert inundation depth [ID] time series to condition rating [CR] time series; convert condition rating [CR] time series to business risk exposure [BRE] time series (Condition×Criticality) (e.g., assuming criticality=6, for example); calculate unacceptable level of risk [RISK] time series from business risk exposure [BRE] time series ([RISK]=[BRE]−Acceptable Level Risk [ALR], where [RISK]>0 or [BRE]>[ALR]) (e.g., assuming [ALR]=19, for example); calculate cumulative [RISK] by summing area under the [RISK] time series curve (e.g., assuming unit [RISK]/Day, for example); and calculate cumulative [PAR] by multiplying [RISK]×Probable Annual Frequency [PAF] of storm event ([PAR]/Day) (assuming [PAF]=0.5, for example. Turning to FIG. 23A-F, for example, shown are graphical representations of each of the preceding steps. It is noted that for each assumed unit or value, that other units or values may also be used, e.g., for criticality, [ALR], per day calculations, [PAF], etc., as may be desired or suitable for a particular purpose without departing from this disclosure.

It is noted that such embodiments may include all preceding steps in the order as written, one or more of the preceding steps in the order as written, all the preceding steps in a different order than written or one or more of the preceding steps in a different order than written, and the like. It is noted that other steps may also be included without departing from the scope of this disclosure or that the preceding steps may include all the steps for a particular embodiment of the disclosed systems and methods.

As described, condition rating [CR] may be presented as a time series, e.g., the area under the curve, where the curve indicates the threshold between acceptable risk and unacceptable risk and the point or area where acceptable risk is exceeded to become unacceptable risk. In an embodiment, the time series may be used to conceptualize the duration of time for each [PAR] score and, for example, whether the risk is high for a relatively short time, a long time, or the like, or whether the risk is low or moderate for a relatively short time, a long time, or the like. In an embodiment, a time series of rain may be provided so that the [PAR] score is not a singular point, but a score relative the duration of the storm. In an embodiment, the [PAR] time series or [PAR-T] may be understood as [PAR] over or divided by duration. In an embodiment, the times series approach may be used to indicate whether an asset is passable/impassible over a certain time period e.g., 5 minutes vs. 5 hours. In an embodiment, the graphical representations may indicate cumulative risk.

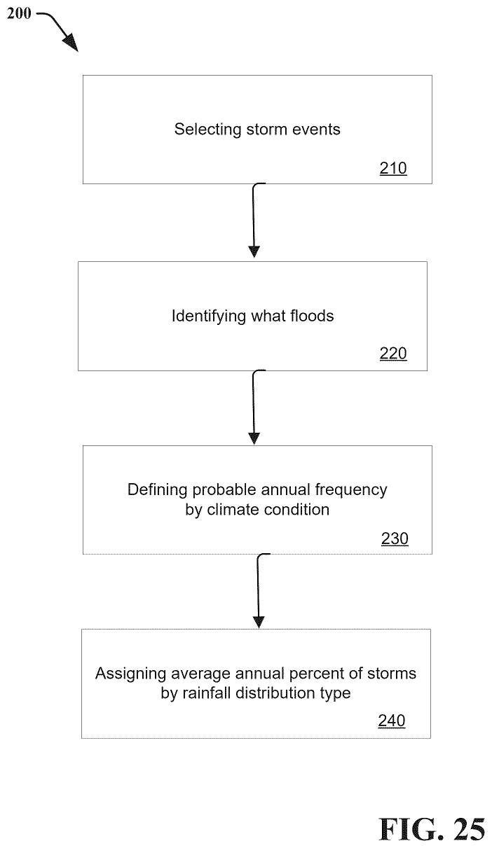

FIGS. 25-38 show embodiments of methods for determining probable annual risk [PAR] for an asset or regional area in accordance with aspects disclosed herein. For example, method 200 shown in FIG. 25 may include the step 210 of selecting storm events, the step 220 of identifying what floods, the step 230 of defining probable annual frequency [PAF] by climate condition, and the step 240 of assigning average rainfall distribution type.

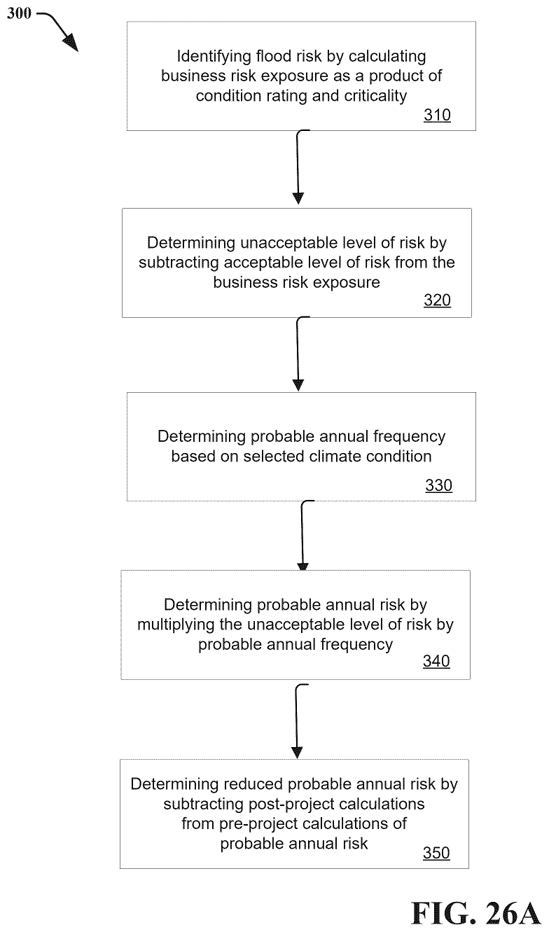

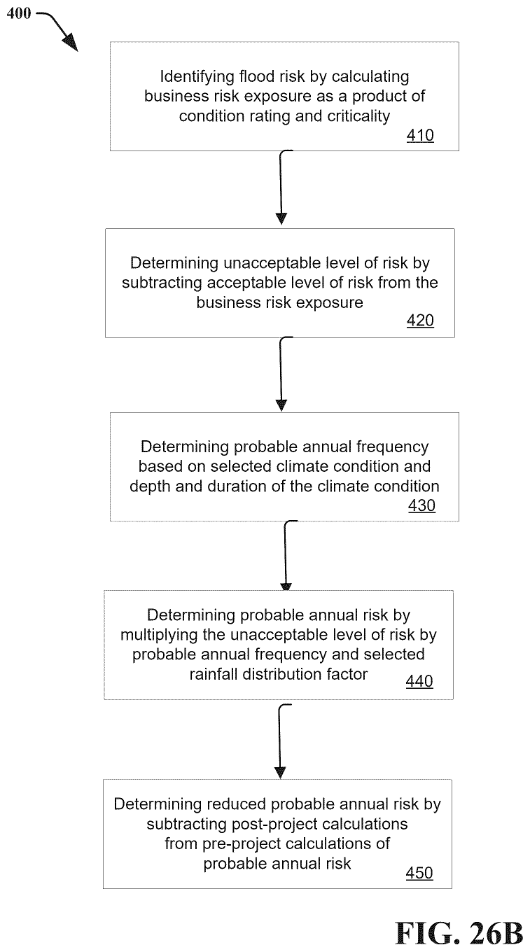

For example, method 300 shown in FIG. 26A may include the step 310 of identifying flood risk by calculating business risk exposure [BRE] as a product of condition rating [CR] and criticality, the step 320 of determining unacceptable level of risk [RISK] by subtracting acceptable level of risk [ALR] from the business risk exposure [BRE], the step 330 of determining probable annual frequency [PAF] based on selected climate condition (e.g., including selecting a data set such as NOAA Atlas values), and the step 340 of determining probable annual risk [PAR] by multiplying the unacceptable level of risk [RISK] by probable annual frequency [PAF]. In an embodiment, method 300 may further include the (optional) step the step 350 of determining reduced probable annual risk [PARR] by subtracting post-project calculations from pre-project calculations of probable annual risk [PAR].

For example, method 400 shown in FIG. 26B may include the step 410 of identifying flood risk by calculating business risk exposure [BRE] as a product of condition rating [CR] and criticality, the step 420 of determining unacceptable level of risk [RISK] by subtracting acceptable level of risk [ALR] from the business risk exposure [BRE], the step 430 of determining probable annual frequency [PAF] based on selected climate condition and depth and duration of the climate condition (e.g., including selecting a data set such as NOAA Atlas values and optionally adjusting by selected percentage value and/or probability distribution factor [PDF], and subsets thereof if applicable), and the step 440 of determining probable annual risk [PAR] by multiplying the unacceptable level of risk [RISK] by probable annual frequency [PAF] and selected rainfall probability distribution factor [PDF]. In an embodiment, method 400 may further include the (optional) step 450 of determining reduced probable annual risk [PARR] by subtracting post-project calculations from pre-project calculations of probable annual risk [PAR].

In an embodiment, once the corresponding [PAR] score is calculated for each storm event for a given rainfall duration (e.g., 24-hr) by rainfall distribution type (e.g., Huff 1^{st} quarter) then the probability of that rainfall distribution type (e.g., 0.125) for a given rainfall duration is multiplied to calculate its portion of the total PAR for that given duration. In an embodiment, the sum of all the [PAR] scores for all rainfall distribution types for all the rainfall depths for a given rainfall duration is its total [PAR]. As described herein, it is noted that the probability distribution factor [PDF] may be provided as a function of probable annual frequency [PAF] (e.g., with out without selected percentage adjustments) or may be provided as a separate variable in the probable annual risk [PAR] calculation.

It is noted that certain steps in any of the foregoing methods may be omitted, interchanged, or reordered consistent with this disclosure and depending on the intended application and desired analysis. It is noted that other steps may be added combined consistent with this disclosure and depending on the intended application and desired analysis. Any steps described in the disclosure may be similarly included, excluded (or provided as optional), combined, and ordered in any manner unless context or this disclosure suggests otherwise. In an embodiment, artificial intelligence may be utilized to provide a [PAR] score or the subset of values that make up a [PAR] score. For example, a model could be utilized that includes rules that trigger certain at depths of inundation, changes in year to year trends, and the like. In an embodiment, the [PAR] score may use a probabilistic model approach.

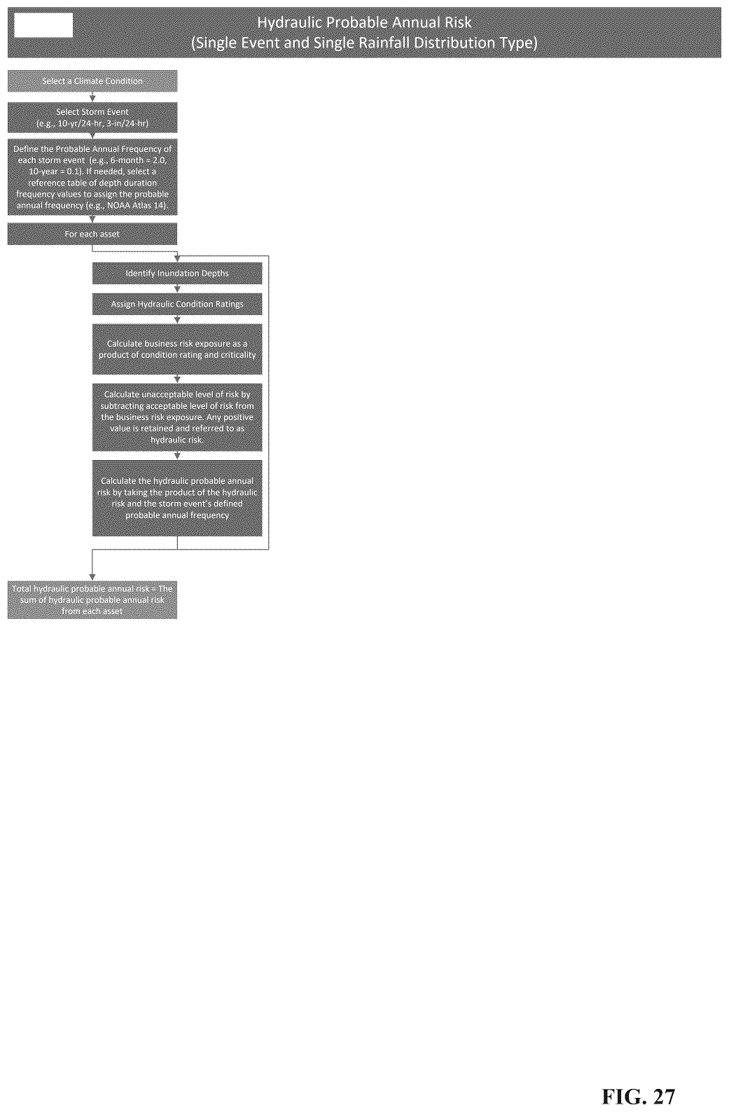

FIG. 27 shows an exemplary method for determining hydraulic probable annual risk using a single rain event and single rainfall distribution type, for example. In an embodiment, the method may comprise selecting a climate condition. In an embodiment, the method may comprise selecting a storm event, (e.g., 10-yr/24-hr, 3-in/24-hr). In an embodiment, the method may comprise defining the probable annual frequency of each storm event (e.g., 6-month=2.0, 10-year=0.1). In an embodiment, the method may comprise selecting a reference table of depth duration frequency values to assign the probable annual frequency (e.g., NOAA Atlas 14).

For each asset, the method may comprise the following steps: identify inundation depths, assign hydraulic condition ratings, calculate business risk exposure as a product of condition rating and criticality, calculate unacceptable level of risk by subtracting acceptable level of risk from the business risk exposure (for example, any positive value may be retained and referred to as hydraulic risk), and calculate the hydraulic probable annual risk by taking the product of the hydraulic risk and the storm event's defined probable annual frequency. In an embodiment, the method may comprise repeating the preceding steps for each asset.

In an embodiment, the method may comprise summing the hydraulic probable annual risk from each asset to determine the total hydraulic probable annual risk.

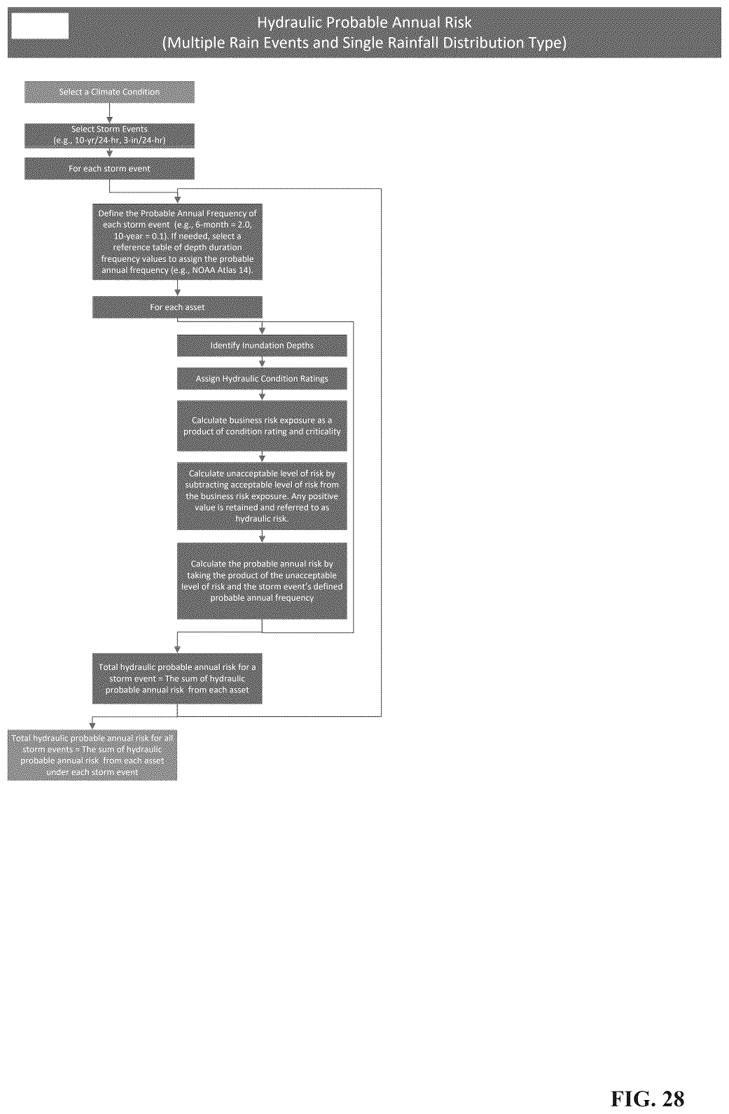

FIG. 28 shows an exemplary method for determining hydraulic probable annual risk using multiple rain events and single rainfall distribution type, for example. In an embodiment, the method may comprise selecting a climate condition. In an embodiment, the method may comprise selecting a storm event (e.g., 10-yr/24-hr, 3-in/24-hr).

For each storm event, the method may comprise the following steps: define the probable annual frequency of each storm event (e.g., 6-month=2.0, 10-year=0.1). In an embodiment, the method may comprise selecting a reference table of depth duration frequency values to assign the probable annual frequency (e.g., NOAA Atlas 14).

For each asset, the method may comprise the following steps: identify inundation depths, assign hydraulic condition ratings, calculate business risk exposure as a product of condition rating and criticality, calculate unacceptable level of risk by subtracting acceptable level of risk from the business risk exposure (for example, any positive value may be retained and referred to as hydraulic risk), and calculate the probable annual risk by taking the product of the unacceptable level of risk and the storm event's defined probable annual frequency. In an embodiment, the method may comprise repeating the preceding steps for each asset.

In an embodiment, the method may comprise summing the hydraulic probable annual risk from each asset to determine the total hydraulic probable annual risk. In an embodiment, the method may comprise repeating the preceding steps for each storm event.

In an embodiment, the method may comprise summing the hydraulic probable annual risk from each asset under each storm event to determine the total hydraulic probable annual risk for all storm events.

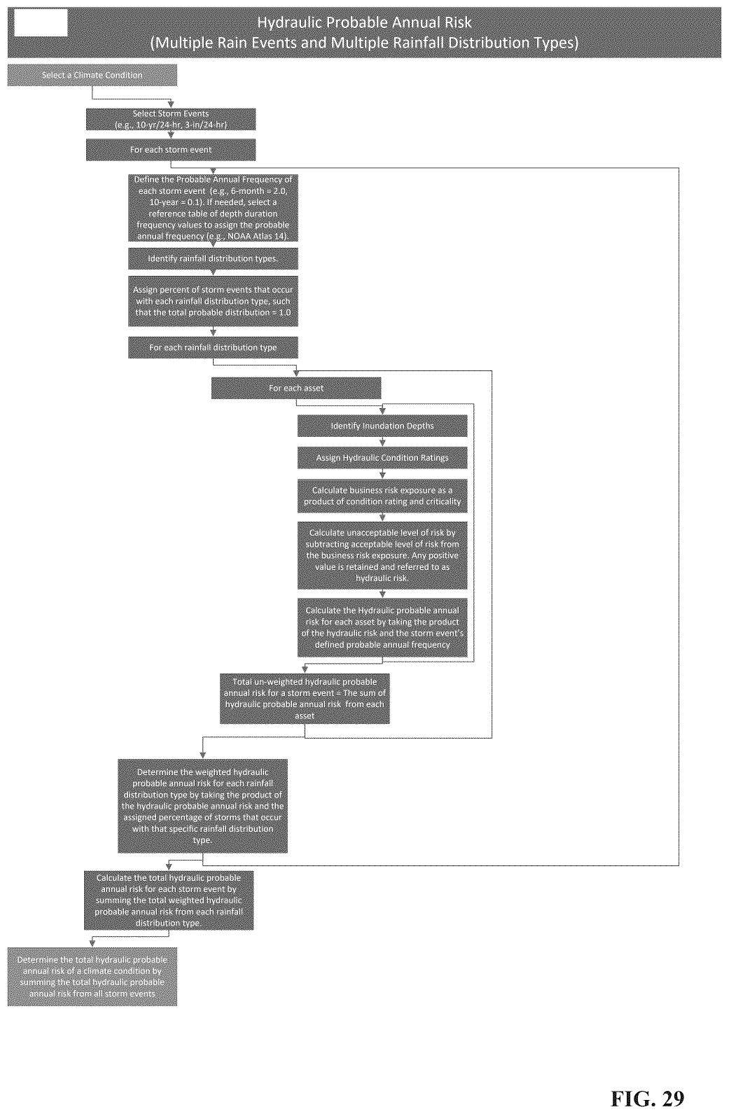

FIG. 29 shows an exemplary method for determining hydraulic probable annual risk using multiple rain events and multiple rainfall distribution types, for example. In an embodiment, the method may comprise selecting a climate condition. In an embodiment, the method may comprise selecting a storm event (e.g., 10-yr/24-hr, 3-in/24-hr).

For each storm event, the method may comprise the following steps: define the probable annual frequency of each storm event (e.g., 6-month=2.0, 10-year=0.1). In an embodiment, the method may comprise selecting a reference table of depth duration frequency values to assign the probable annual frequency (e.g., NOAA Atlas 14). For each storm event, the method may further comprise the following steps: identify rainfall distribution types and assign percent of storm events that occur with each rainfall distribution type, such that the total probable distribution=1.0.

For rainfall distribution type and for each asset, the method may comprise the following steps: identify inundation depths, assign hydraulic condition ratings, calculate business risk exposure as a product of condition rating and criticality, calculate unacceptable level of risk by subtracting acceptable level of risk from the business risk exposure (for example, any positive value may be retained and referred to as hydraulic risk), and calculate the hydraulic probable annual risk for each asset by taking the product of the hydraulic risk and the storm event's defined probable annual frequency. In an embodiment, the method may comprise repeating the preceding steps for each asset.

In an embodiment, the method may comprise summing the hydraulic probable annual risk from each asset to determine the total un-weighted hydraulic probable annual risk. In an embodiment, the method may comprise repeating the preceding steps for each rainfall distribution type.

In an embodiment, the method may comprise determining the weighted hydraulic probable annual risk for each rainfall distribution type by taking the product of the hydraulic probable annual risk and the assigned percentage of storms that occur with that specific rainfall distribution type. In an embodiment, the method may comprise repeating the preceding steps for each storm event.

In an embodiment, the method may comprise calculating the total hydraulic probable annual risk for each storm event by summing the total weighted hydraulic probable annual risk from each rainfall distribution type. In an embodiment, the method may comprise determining the total hydraulic probable annual risk of a climate condition by summing the total hydraulic probable annual risk from all storm events.

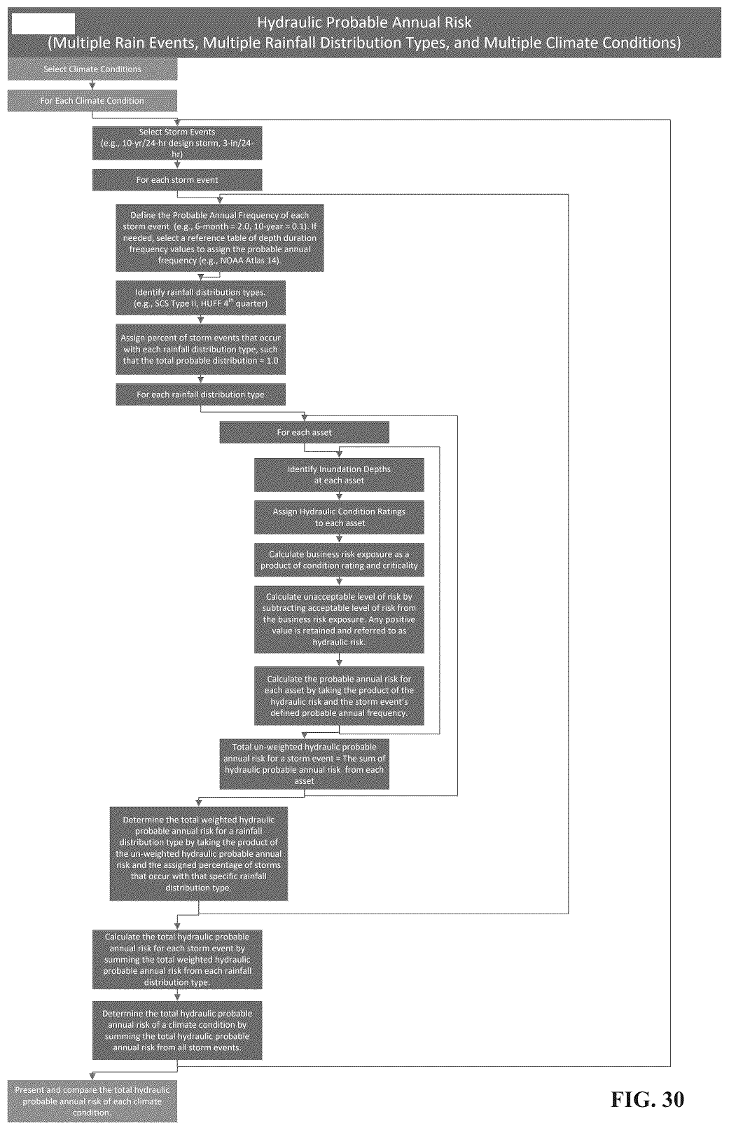

FIG. 30 shows an exemplary method for determining hydraulic probable annual risk using multiple rain events, multiple rainfall distribution types, and multiple climate conditions, for example. In an embodiment, the method may comprise selecting a climate condition.

For each climate condition, the method may comprise selecting a storm event (e.g., 10-yr/24-hr, 3-in/24-hr).

For each storm event, the method may comprise the following steps: define the probable annual frequency of each storm event (e.g., 6-month=2.0, 10-year=0.1). In an embodiment, the method may comprise selecting a reference table of depth duration frequency values to assign the probable annual frequency (e.g., NOAA Atlas 14). For each storm event, the method may further comprise the following steps: identify rainfall distribution types and assign percent of storm events that occur with each rainfall distribution type, such that the total probable distribution=1.0.

For rainfall distribution type and for each asset, the method may comprise the following steps: identify inundation depths at each asset, assign hydraulic condition ratings to each asset, calculate business risk exposure as a product of condition rating and criticality, calculate unacceptable level of risk by subtracting acceptable level of risk from the business risk exposure (for example, any positive value may be retained and referred to as hydraulic risk), and calculate the probable annual risk for each asset by taking the product of the hydraulic risk and the storm event's defined probable annual frequency. In an embodiment, the method may comprise repeating the preceding steps for each asset.

In an embodiment, the method may comprise summing the hydraulic probable annual risk for a storm event to determine the total un-weighted hydraulic probable annual risk. In an embodiment, the method may comprise repeating the preceding steps for each rainfall distribution type.

In an embodiment, the method may comprise determining the total weighted hydraulic probable annual risk for a rainfall distribution type by taking the product of the un-weighted hydraulic probable annual risk and the assigned percentage of storms that occur with that specific rainfall distribution type. In an embodiment, the method may comprise repeating the preceding steps for each storm event.

In an embodiment, the method may comprise calculating the total hydraulic probable annual risk for each storm event by summing the total weighted hydraulic probable annual risk from each rainfall distribution type. In an embodiment, the method may comprise determining the total hydraulic probable annual risk of a climate condition by summing the total hydraulic probable annual risk from all storm events. In an embodiment, the method may comprise repeating the preceding steps for each climate condition.

In an embodiment, the method may comprise presenting and comparing the total hydraulic probable annual risk of each climate condition.

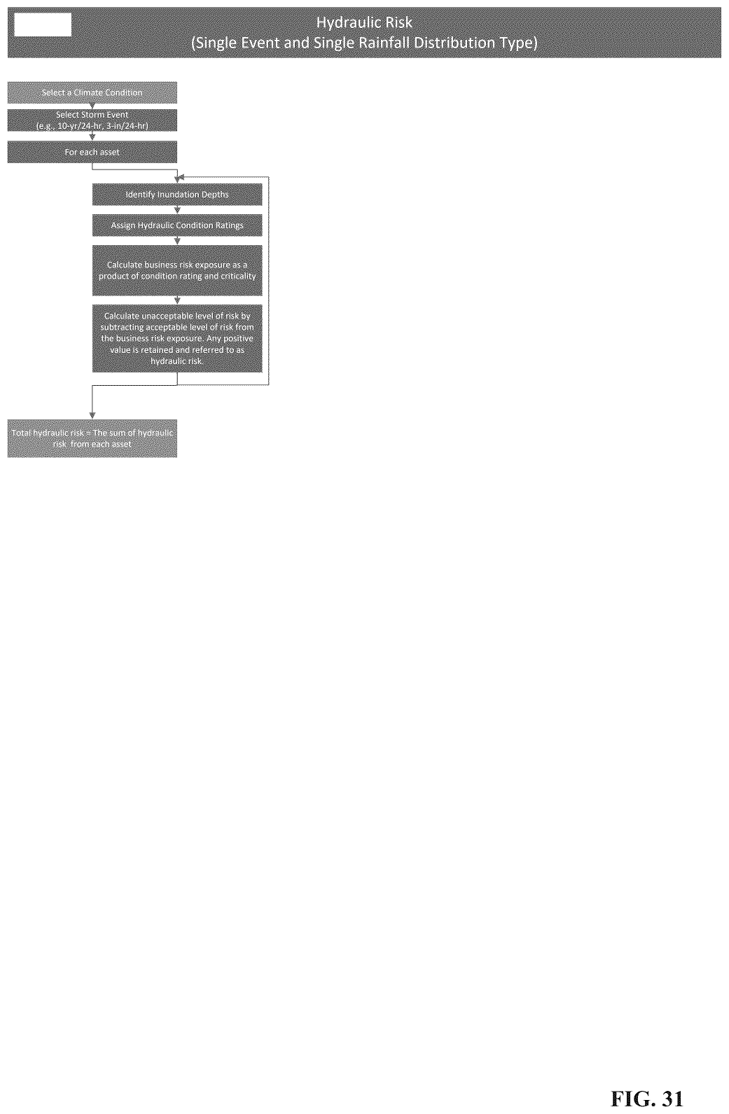

FIG. 31 shows an exemplary method for determining hydraulic risk using a single rain event and single rainfall distribution type, for example. In an embodiment, the method may comprise selecting a climate condition. In an embodiment, the method may comprise selecting a storm event, (e.g., 10-yr/24-hr, 3-in/24-hr).

For each asset, the method may comprise the following steps: identify inundation depths, assign hydraulic condition ratings, calculate business risk exposure as a product of condition rating and criticality, and calculate unacceptable level of risk by subtracting acceptable level of risk from the business risk exposure (for example, any positive value may be retained and referred to as hydraulic risk). In an embodiment, the method may comprise repeating the preceding steps for each asset.

In an embodiment, the method may comprise summing the hydraulic risk from each asset to determine the total hydraulic risk.

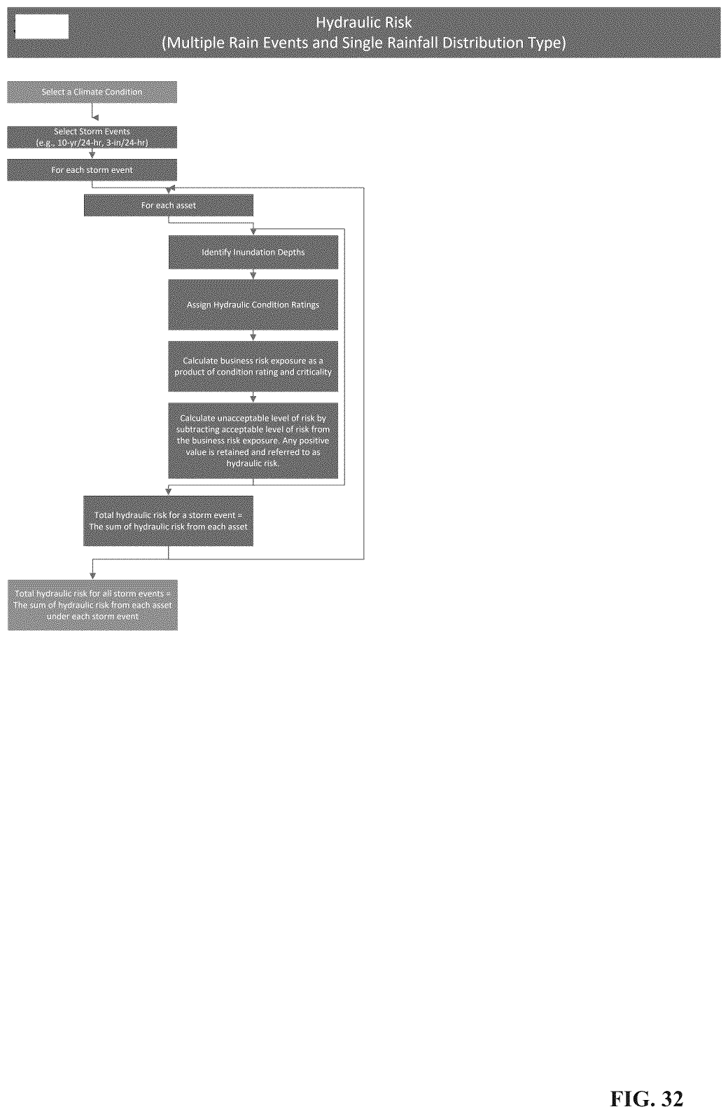

FIG. 32 shows an exemplary method for determining hydraulic risk using multiple rain events and single rainfall distribution type, for example. In an embodiment, the method may comprise selecting a climate condition. In an embodiment, the method may comprise selecting a storm event, (e.g., 10-yr/24-hr, 3-in/24-hr).

For each storm event and each asset, the method may comprise the following steps: identify inundation depths, assign hydraulic condition ratings, calculate business risk exposure as a product of condition rating and criticality, and calculate unacceptable level of risk by subtracting acceptable level of risk from the business risk exposure (for example, any positive value may be retained and referred to as hydraulic risk). In an embodiment, the method may comprise repeating the preceding steps for each asset.

In an embodiment, the method may comprise summing the hydraulic risk from each asset to determine the total hydraulic risk. In an embodiment, the method may comprise repeating the preceding steps for each storm event.

In an embodiment, the method may comprise summing the hydraulic risk from each asset under each storm event to determine the total hydraulic risk for all storm events.

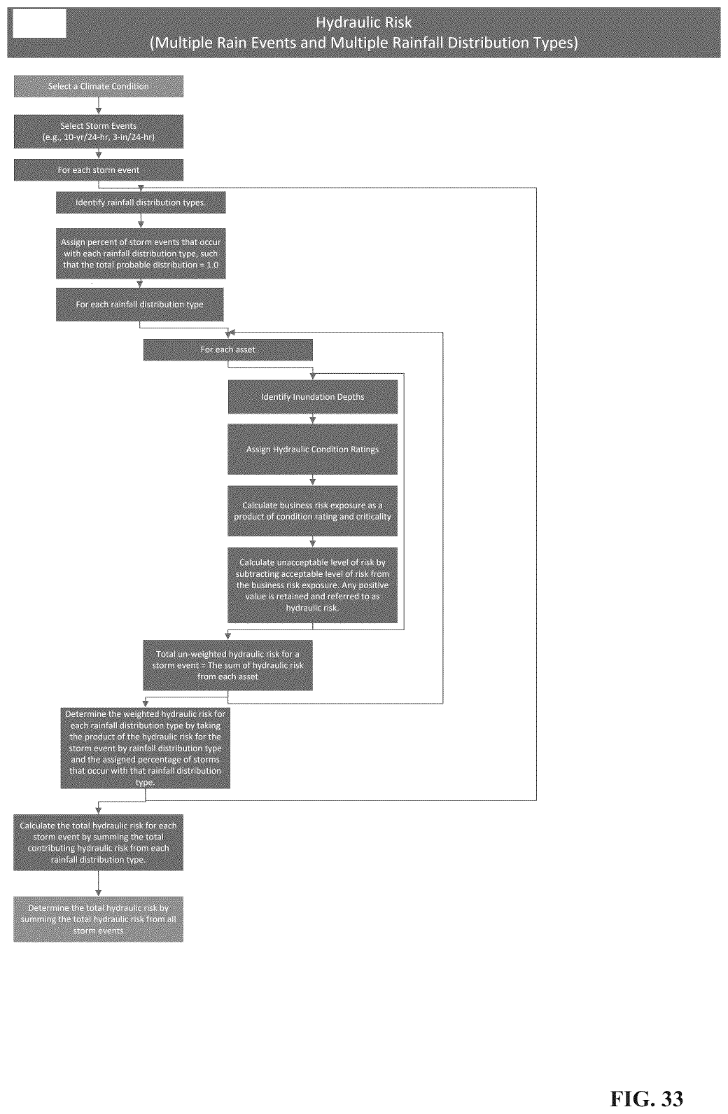

FIG. 33 shows an exemplary method for determining hydraulic risk using multiple rain events and multiple rainfall distribution types, for example. In an embodiment, the method may comprise selecting a climate condition. In an embodiment, the method may comprise selecting a storm event, (e.g., 10-yr/24-hr, 3-in/24-hr).

For each storm event, the method may comprise the following steps: identify rainfall distribution types and assign percent of storm events that occur with each rainfall distribution type, such that the total probable distribution=1.0.

For each rainfall distribution type and each asset, the method may comprise the following steps: identify inundation depths, assign hydraulic condition ratings, calculate business risk exposure as a product of condition rating and criticality, and calculate unacceptable level of risk by subtracting acceptable level of risk from the business risk exposure (for example, any positive value may be retained and referred to as hydraulic risk). In an embodiment, the method may comprise repeating the preceding steps for each asset.

In an embodiment, the method may comprise summing the hydraulic risk from each asset to determine the total un-weighted hydraulic risk. In an embodiment, the method may comprise repeating the preceding steps for each rainfall distribution type.

In an embodiment, the method may comprise determining the weighted hydraulic risk for each rainfall distribution type by taking the product of the hydraulic risk for the storm event by rainfall distribution type and the assigned percentage of storms that occur with that rainfall distribution type. In an embodiment, the method may comprise repeating the preceding steps for each storm event.

In an embodiment, the method may comprise calculating the total hydraulic risk for each storm event by summing the total contributing hydraulic risk from each rainfall distribution type. In an embodiment, the method may comprise determining the total hydraulic risk by summing the total hydraulic risk from all storm events.

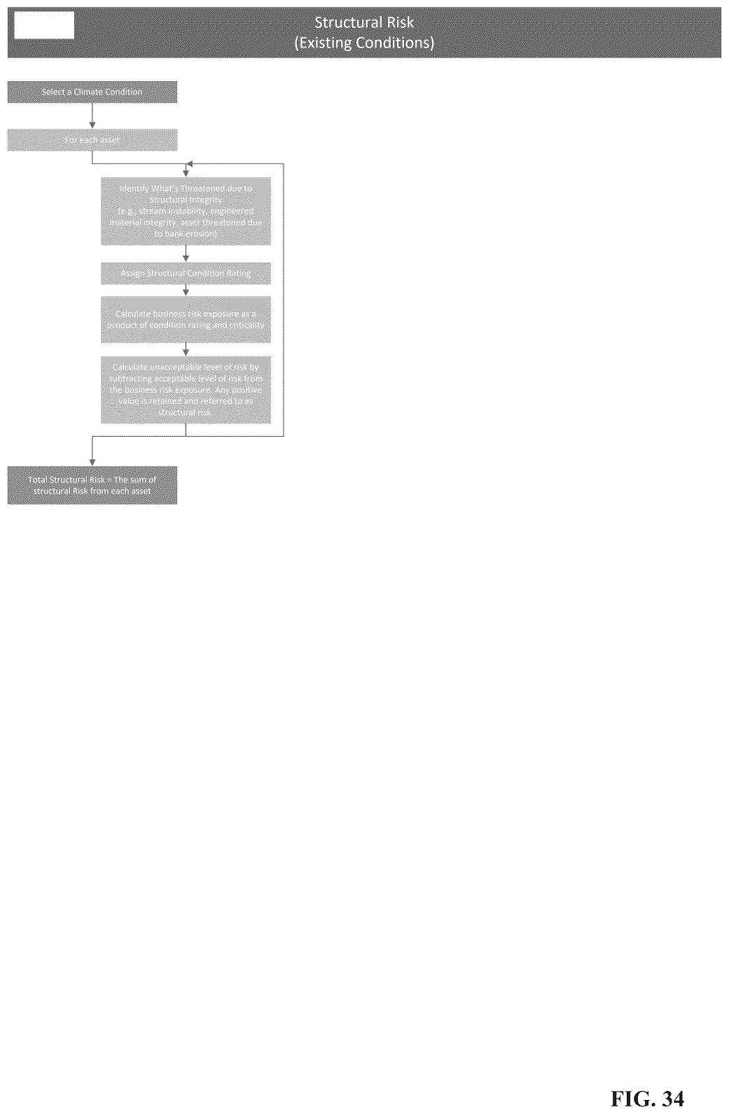

FIG. 34 shows an exemplary method for determining structural risk using existing conditions, for example. In an embodiment, the method may comprise selecting a climate condition.

For each asset, the method may comprise the following steps: identify what is threatened due to structural integrity (e.g., stream instability, engineered material integrity, asset threatened due to bank erosion), assign structural condition rating, calculate business risk exposure as a product of condition rating and criticality, and calculate unacceptable level of risk by subtracting acceptable level of risk from the business risk exposure (for example, any positive value may be retained and referred to as structural risk). In an embodiment, the method may comprise repeating the preceding steps for each asset.

In an embodiment, the method may comprise summing the structural risk from each asset to determine total structural risk.

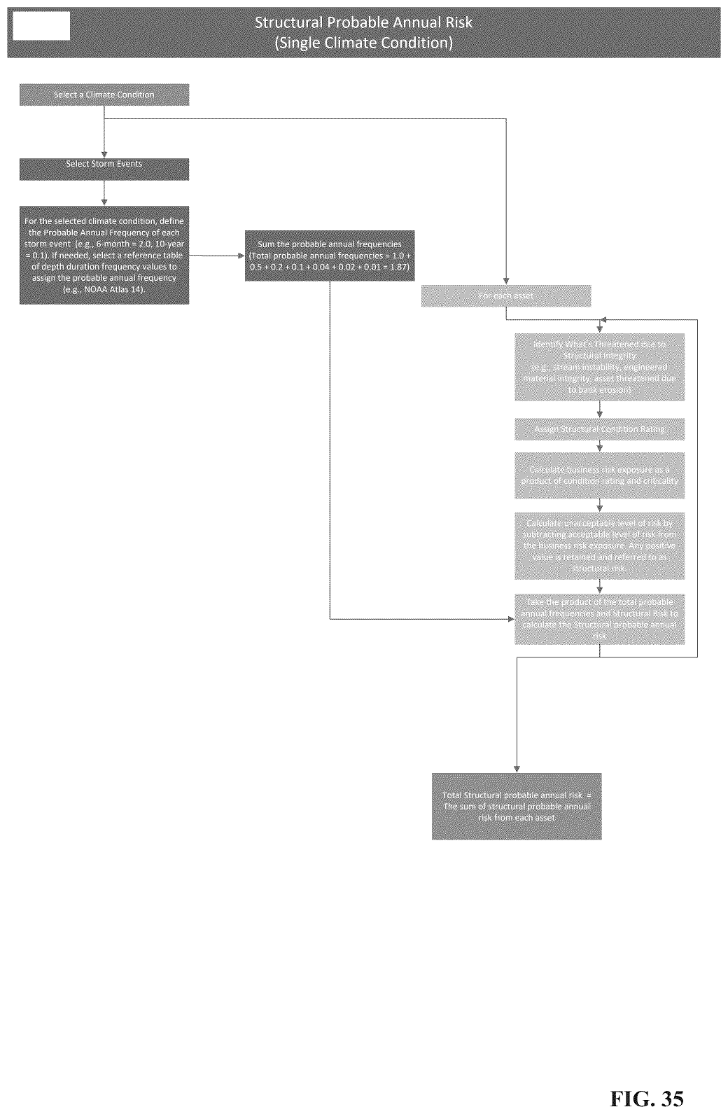

FIG. 35 shows an exemplary method for determining structural probable annual risk using a single climate condition, for example. In an embodiment, the method may comprise selecting a climate condition. In an embodiment, the method may comprise selecting storm event. For the selected climate condition, the method may comprise the defining probable annual frequency of each storm event (e.g., 6-month=2.0, 10-year=0.1). In an embodiment, the method may comprise selecting a reference table of depth duration frequency values to assign the probable annual frequency (e.g., NOAA Atlas 14). In an embodiment, the method may comprise summing the probable annual frequencies (e.g., total probable annual frequencies=1.0+0.5+0.2+0.1+0.04+0.02+0.01=1.87).

For each asset, the method may comprise the following steps: identify what is threatened due to structural integrity (e.g., stream instability, engineered material integrity, asset threatened due to bank erosion), assign structural condition rating, calculate business risk exposure as a product of condition rating and criticality, and calculate unacceptable level of risk by subtracting acceptable level of risk from the business risk exposure (for example, any positive value may be retained and referred to as structural risk). In an embodiment, the method may comprise taking the product of the total probable annual frequencies and structural risk to calculate the structural probable annual risk. The latter step may further include accounting for the sum the probable annual frequencies (e.g., total probable annual frequencies=1.0+0.5+0.2+0.1+0.04+0.02+0.01=1.87). In an embodiment, the method may comprise repeating the preceding steps for each asset.

In an embodiment, the method may comprise summing the structural probable annual risk from each asset to determine total structural probable annual risk.

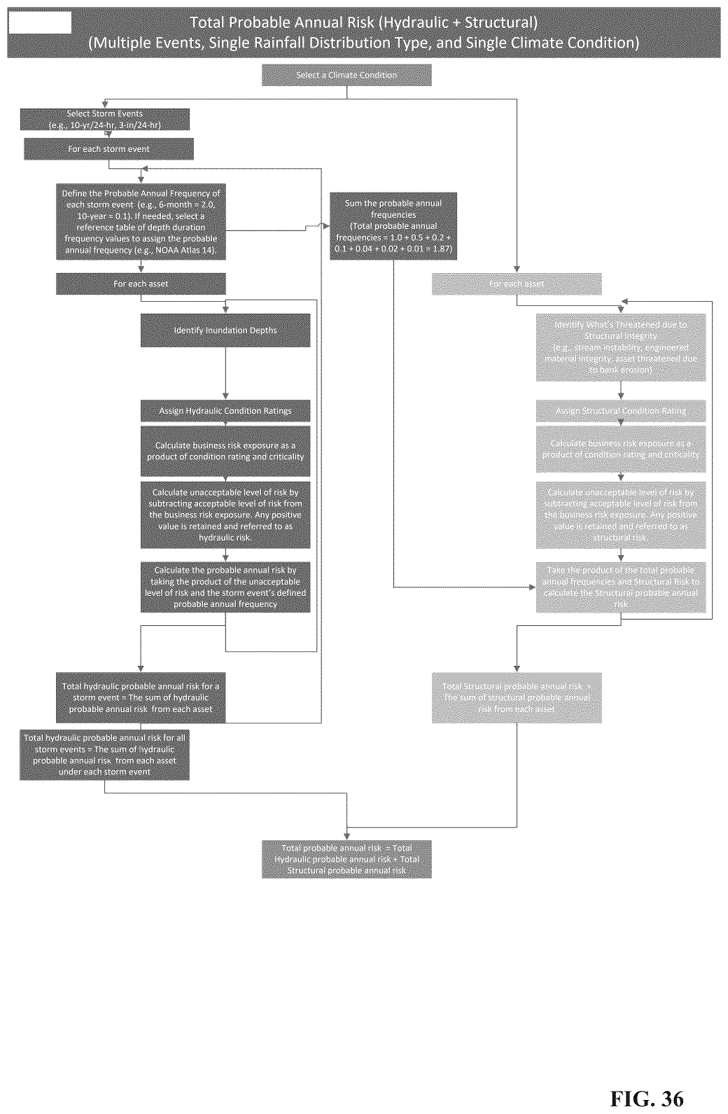

FIG. 36 shows an exemplary method for determining total probable annual risk (hydraulic and structural) using multiple rainfall events, a single rainfall distribution type, and a single climate condition, for example. In an embodiment, the method may comprise selecting a climate condition. In an embodiment, the method may comprise selecting storm event (e.g., 10-yr/24-hr, 3-in/24-hr).

For each storm event, the method may comprise defining the probable annual frequency of each storm event (e.g., 6-month=2.0, 10-year=0.1). In an embodiment, the method may comprise selecting a reference table of depth duration frequency values to assign the probable annual frequency (e.g., NOAA Atlas 14). In an embodiment, the method may comprise summing the probable annual frequencies (e.g., total probable annual frequencies=1.0+0.5+0.2+0.1+0.04+0.02+0.01=1.87).

For each asset, the method may comprise the following steps: identify inundation depths, assign hydraulic condition ratings, calculate business risk exposure as a product of condition rating and criticality, calculate unacceptable level of risk by subtracting acceptable level of risk from the business risk exposure (for example, any positive value is retained and referred to as hydraulic risk), calculate the probable annual risk by taking the product of the unacceptable level of risk and the storm event's defined probable annual frequency. In an embodiment, the method may comprise repeating the preceding steps for each asset.

In an embodiment, the method may comprise summing the hydraulic probable annual risk from each asset to determine total hydraulic probable annual risk for a storm event. In an embodiment, the method may comprise repeating the preceding steps for each storm event.

In an embodiment, the method may comprise summing the hydraulic probable annual risk from each asset under each storm event to determine the total hydraulic probable annual risk for all storm events.

For each asset, the method may comprise the following steps: identify what is threatened due to structural integrity (e.g., stream instability, engineered material integrity, asset threatened due to bank erosion), assign structural condition rating, calculate business risk exposure as a product of condition rating and criticality, and calculate unacceptable level of risk by subtracting acceptable level of risk from the business risk exposure (for example, any positive value may be retained and referred to as structural risk). In an embodiment, the method may comprise taking the product of the total probable annual frequencies and structural risk to calculate the structural probable annual risk. The latter step may further include accounting for the sum the probable annual frequencies (e.g., total probable annual frequencies=1.0+0.5+0.2+0.1+0.04+0.02+0.01=1.87). In an embodiment, the method may comprise repeating the preceding steps for each asset.

In an embodiment, the method may comprise summing the structural probable annual risk from each asset to determine total structural probable annual risk.

In an embodiment, the method may comprise summing the total hydraulic probable annual risk with the total structural probable annual risk to determine the total probable annual risk.

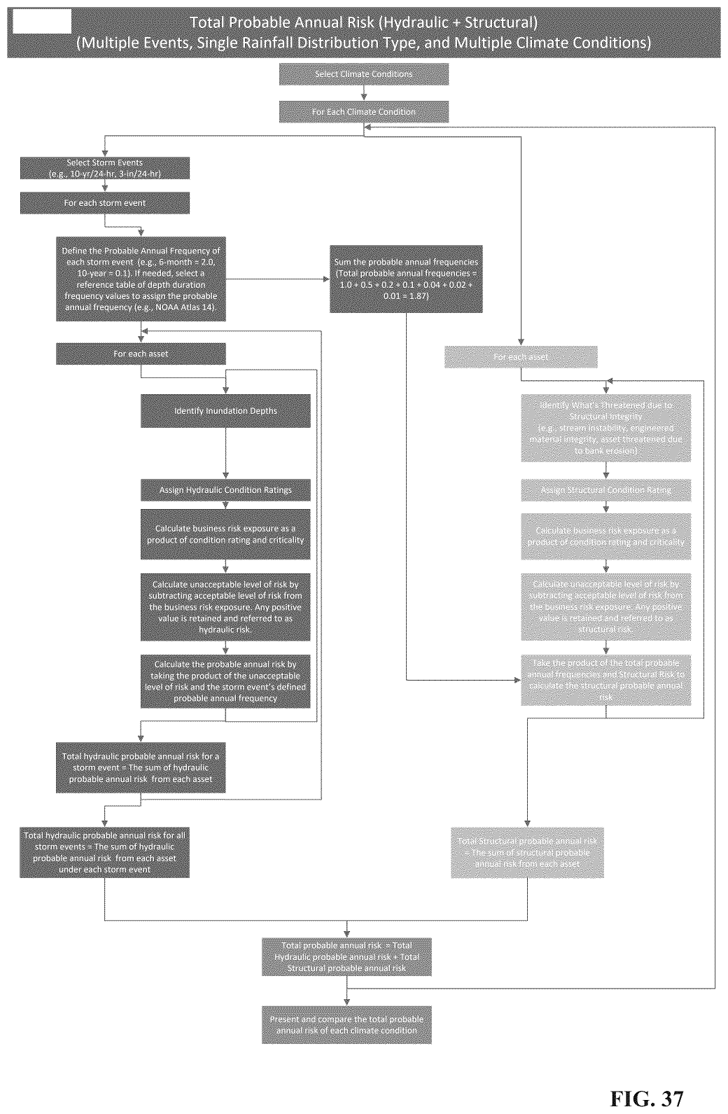

FIG. 37 shows an exemplary method for determining total probable annual risk (hydraulic and structural) using multiple rainfall events, a single rainfall distribution type, and multiple climate conditions, for example. In an embodiment, the method may comprise selecting a climate condition.

For each climate condition, the method may comprise selecting storm event (e.g., 10-yr/24-hr, 3-in/24-hr).

For each storm event, the method may comprise defining the probable annual frequency of each storm event (e.g., 6-month=2.0, 10-year=0.1). In an embodiment, the method may comprise selecting a reference table of depth duration frequency values to assign the probable annual frequency (e.g., NOAA Atlas 14). In an embodiment, the method may comprise summing the probable annual frequencies (e.g., total probable annual frequencies=1.0+0.5+0.2+0.1+0.04+0.02+0.01=1.87).

For each asset, the method may comprise the following steps: identify inundation depths, assign hydraulic condition ratings, calculate business risk exposure as a product of condition rating and criticality, calculate unacceptable level of risk by subtracting acceptable level of risk from the business risk exposure (for example, any positive value is retained and referred to as hydraulic risk), calculate the probable annual risk by taking the product of the unacceptable level of risk and the storm event's defined probable annual frequency. In an embodiment, the method may comprise repeating the preceding steps for each asset.

In an embodiment, the method may comprise summing the hydraulic probable annual risk from each asset to determine total hydraulic probable annual risk for a storm event. In an embodiment, the method may comprise repeating the preceding steps for each storm event.

In an embodiment, the method may comprise summing the hydraulic probable annual risk from each asset under each storm event to determine the total hydraulic probable annual risk for all storm events.

For each climate condition and each asset, the method may comprise the following steps: identify what is threatened due to structural integrity (e.g., stream instability, engineered material integrity, asset threatened due to bank erosion), assign structural condition rating, calculate business risk exposure as a product of condition rating and criticality, and calculate unacceptable level of risk by subtracting acceptable level of risk from the business risk exposure (for example, any positive value may be retained and referred to as structural risk). In an embodiment, the method may comprise taking the product of the total probable annual frequencies and structural risk to calculate the structural probable annual risk. The latter step may further include accounting for the sum the probable annual frequencies (e.g., total probable annual frequencies=1.0+0.5+0.2+0.1+0.04+0.02+0.01=1.87). In an embodiment, the method may comprise repeating the preceding steps for each asset.

In an embodiment, the method may comprise summing the structural probable annual risk from each asset to determine total structural probable annual risk.

In an embodiment, the method may comprise summing the total hydraulic probable annual risk with the total structural probable annual risk to determine the total probable annual risk. In an embodiment, the method may comprise repeating the preceding steps for each climate condition. In an embodiment, the method may comprise presenting and comparing the total probable annual risk of each climate condition.

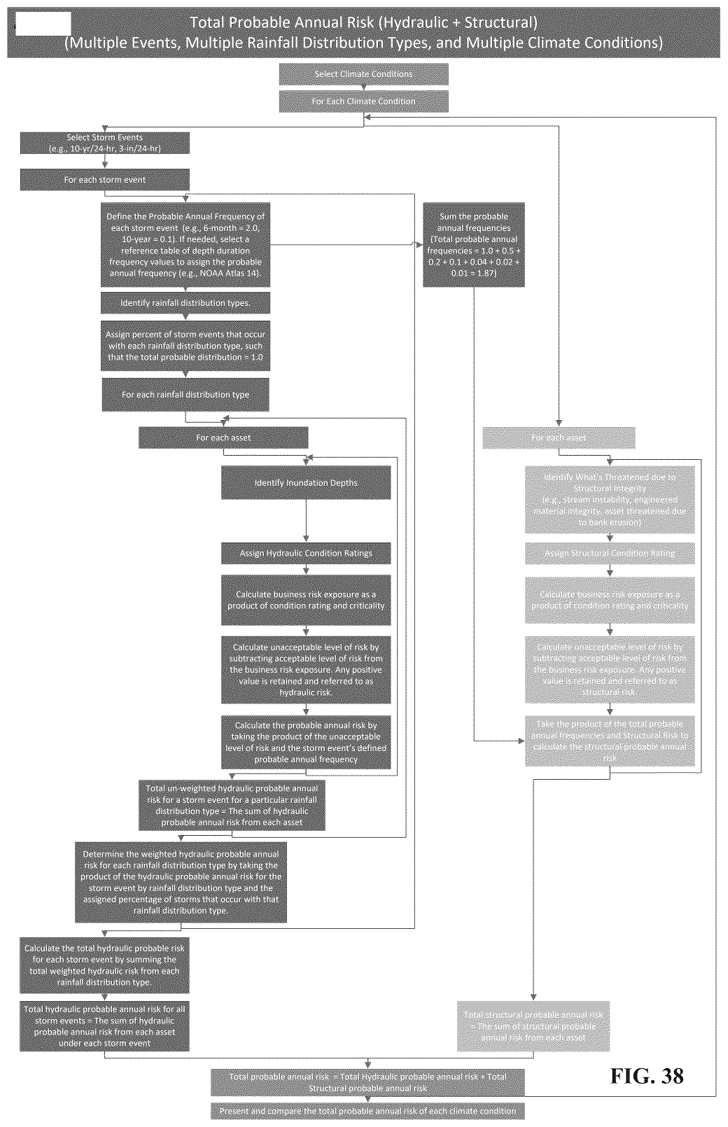

FIG. 38 shows an exemplary method for determining total probable annual risk (hydraulic and structural) using multiple rainfall events, multiple rainfall distribution types, and multiple climate conditions, for example. In an embodiment, the method may comprise selecting a climate condition.

For each climate condition, the method may comprise selecting storm event (e.g., 10-yr/24-hr, 3-in/24-hr).

For each storm event, the method may comprise defining the probable annual frequency of each storm event (e.g., 6-month=2.0, 10-year=0.1). In an embodiment, the method may comprise selecting a reference table of depth duration frequency values to assign the probable annual frequency (e.g., NOAA Atlas 14). In an embodiment, the method may comprise summing the probable annual frequencies (e.g., total probable annual frequencies=1.0+0.5+0.2+0.1+0.04+0.02+0.01=1.87). In an embodiment, the method may further comprise the following steps: identify rainfall distribution types and assign percent of storm events that occur with each rainfall distribution type, such that the total probable distribution=1.0

For each rainfall distribution type and each asset, the method may comprise the following steps: identify inundation depths, assign hydraulic condition ratings, calculate business risk exposure as a product of condition rating and criticality, calculate unacceptable level of risk by subtracting acceptable level of risk from the business risk exposure (for example, any positive value is retained and referred to as hydraulic risk), calculate the probable annual risk by taking the product of the unacceptable level of risk and the storm event's defined probable annual frequency. In an embodiment, the method may comprise repeating the preceding steps for each asset.

In an embodiment, the method may comprise summing the hydraulic probable annual risk from each asset to determine total un-weighted hydraulic probable annual risk for a storm event for a particular distribution type. In an embodiment, the method may comprise repeating the preceding steps for each rainfall distribution type.

In an embodiment, the method may comprise determining the weighted hydraulic probable annual risk for each rainfall distribution type by taking the product of the hydraulic probable annual risk for the storm event by rainfall distribution type and the assigned percentage of storms that occur with that rainfall distribution type. In an embodiment, the method may comprise repeating the preceding steps for each storm event.

In an embodiment, the method may comprise calculating the total hydraulic probable risk for each storm event by summing the total weighted hydraulic risk from each rainfall distribution type. In an embodiment, the method may comprise summing the hydraulic probable annual risk from each asset under each storm event to determine the total hydraulic probable annual risk for all storm events.

For each climate condition and each asset, the method may comprise the following steps: identify what is threatened due to structural integrity (e.g., stream instability, engineered material integrity, asset threatened due to bank erosion), assign structural condition rating, calculate business risk exposure as a product of condition rating and criticality, and calculate unacceptable level of risk by subtracting acceptable level of risk from the business risk exposure (for example, any positive value may be retained and referred to as structural risk). In an embodiment, the method may comprise taking the product of the total probable annual frequencies and structural risk to calculate the structural probable annual risk. The latter step may further include accounting for the sum the probable annual frequencies (e.g., total probable annual frequencies=1.0+0.5+0.2+0.1+0.04+0.02+0.01=1.87). In an embodiment, the method may comprise repeating the preceding steps for each asset.

In an embodiment, the method may comprise summing the structural probable annual risk from each asset to determine total structural probable annual risk.

In an embodiment, the method may comprise summing the total hydraulic probable annual risk with the total structural probable annual risk to determine the total probable annual risk. In an embodiment, the method may comprise repeating the preceding steps for each climate condition. In an embodiment, the method may comprise presenting and comparing the total probable annual risk of each climate condition.

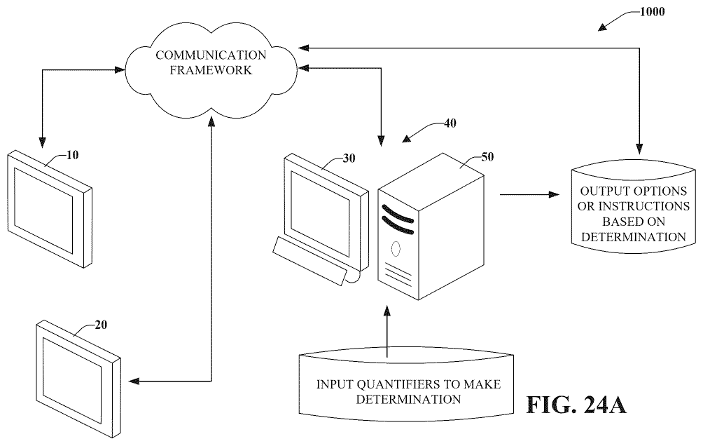

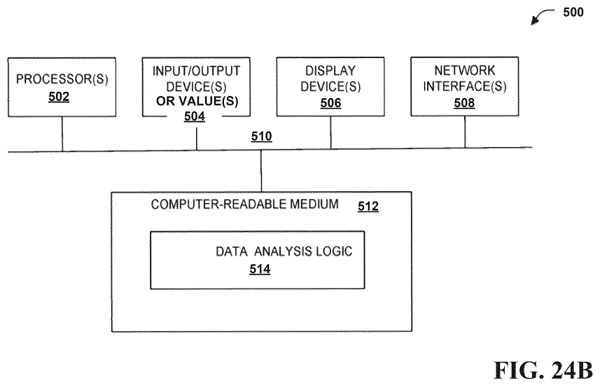

FIGS. 24A-B show embodiments of systems and methods that may be used to facilitate the described assessments in accordance with aspects disclosed herein. It is further noted that these systems and methods may include or utilize actual computers or hardware systems as well as cloud computing or virtual computers. In an embodiment, the systems and methods may include or utilize exclusively cloud computing or virtual computers. In an embodiment, the systems and methods may include or utilize a combination of actual computers or hardware systems and cloud computing or virtual computers. For example, FIG. 24A shows system 1000. System 1000 may include a display 30 and processor 50, together server 40. The server 40 may communicate with one or more network devices 10, 20, over a communication framework to receive information.

For example, an individual at the site of a city structure may input data related to condition rating of the city structure or may input information related to observations such as condition of soil, rivers, and the like. Input data may also include sensors such as water sensors, temperature sensors, wind sensors, and the like, or could include camera systems to provide visual data. It is noted that inputs may also be directly inputted by a user, or automatically inputted by the described sensors to be used with the disclosed systems and methods herein.

Server 40 may also receive various inputs such as distribution type, historical rainfall charts, and any other values described herein used in the determination of probable annual risk [PAR]. Server 40 may analyze the inputs with the methods and calculations described herein and may provide an output. For example, the output may include recommendations for priority projects, support urgent storm event planning and field response, indicate high risk city structures vs low risk city structures, assess maximum capacities of the sewer systems or portions of the sewer system, and when/if such capacities may be reached, and the like.

It is also noted that the system 1000 may comprise only the server (e.g., no external networks or processing systems, no communication framework) and may rely solely on inputted information related the described variables to carry out the assessments and provide output.

Similarly, FIG. 24B shows processing system 500 configured to perform various aspects described herein, including, for example, probable annual risk [PAR] assessments. Processing system 500 is generally an example of an electronic device configured to execute computer-executable instructions, such as those derived from compiled or interpreted computer code, including without limitation personal computers, tablet computers, servers, smart phones, smart devices, wearable devices, augmented or virtual reality devices, and others.

In an embodiment, processing system 500 includes one or more processors 502, one or more input/output devices 504, one or more display devices 506, and one or more network interfaces 508 through which processing system 500 is connected to one or more networks (e.g., a local network, an intranet, the internet, or any other group of processing systems communicatively connected to each other), and computer-readable medium 512. In an embodiment, the components are coupled by a bus 510, which may generally be configured for data or power exchange amongst the components. Bus 510 may be representative of multiple buses, while only one is depicted for simplicity.

Processor(s) 502 are generally configured to retrieve and execute instructions stored in one or more memories, including local memories like the computer-readable medium 512, as well as remote memories and data stores. Similarly, processor(s) 502 are configured to retrieve and store application data residing in local memories like the computer-readable medium 512, as well as remote memories and data stores. More generally, bus 510 is configured to transmit programming instructions and application data among the processor(s) 502, display device(s) 506, network interface(s) 508, and computer-readable medium 512. In certain embodiments, processor(s) 502 are included to be representative of one or more central processing units (CPUs), graphics processing units (GPUs), tensor processing units (TPUs), accelerators, and other processing devices.

Input/output device(s) 504 may include any device, mechanism, system, interactive display, or various other hardware components for communicating information between processing system 500 and a user of processing system 500. For example, input/output device(s) 504 may include input hardware, such as a keyboard, touch screen, button, microphone, or other device for receiving inputs from the user. Input/output device(s) 504 may further include display hardware, such as, for example, a monitor, a video card, or other device for sending or presenting visual data to the user. In certain embodiments, input/output device(s) 504 is or includes a graphical user interface. Input devices may also include sensors such as water sensors, temperature sensors, wind sensors, and the like, or could include camera systems to provide visual data. It is noted that inputs may also be directly inputted by a user, such as an individual at the cite of a city structure to provide condition rating or other assessment to be used with the described systems and methods herein.

Display device(s) 506 may generally include any device configured to display data, information, graphics, user interface elements, and the like to a user. For example, display device(s) 506 may include internal and external displays, such as an internal display of a tablet computer or an external display for a server computer or a projector. Display device(s) 506 may further include displays for devices, such as augmented, virtual, or extended reality devices.

Network interface(s) 508 provide processing system 500 access to external networks and processing systems. Network interface(s) 508 can generally be any device capable of transmitting or receiving data through a wired or wireless network connection. Accordingly, network interface(s) 508 can include a transceiver for sending or receiving wired or wireless communication. For example, Network interface(s) 508 may include an antenna, a modem, a LAN port, a Wi-Fi card, a WiMAX card, cellular communications hardware, near-field communication (NFC) hardware, satellite communication hardware, or any wired or wireless hardware for communicating with other networks or devices/systems. In certain embodiments, network interface(s) 508 includes hardware configured to operate in accordance with the Bluetooth® wireless communication protocol.

It is also noted that the system 500 may comprise only the single display device and processor (e.g., no external networks or processing systems, no communication framework) and may rely solely on inputted information related the described variables to carry out the assessments and provide output.

Computer-readable medium 512 may be a volatile memory, such as a random access memory (RAM), or a non-volatile memory, such as non-volatile random access memory, phase change random access memory, or the like. In this example, computer-readable medium 512 includes sensor data analysis logic 514. The sensor data analysis logic 514 can be performed by the flexible circuit board or external processing device.

Note FIGS. 24A-B are examples of systems consistent with aspects described herein, and other processing systems having combined, additional, alternative, or fewer components are possible consistent with this disclosure.

Although the disclosure generally describes calculating a probable annual risk relative to flooding and sewer infrastructure of a region based on storm type (e.g., duration, severity, frequency, etc.), it is noted that the risk analysis may be applied to other industries and data where a calculated risk is desired. For example, the probable annual risk [PAR] calculations and analysis could be adapted to other city structures, such as status of electrical grids and internet or cellular network connectivity based on storms, as well as city roads and bridge infrastructure based on predicted usage and population growth, hospital capacities based on mass casualty events, financial risks of business or individuals, and the like. It is noted that any steps or calculations herein may include sample data, actual data (e.g., from rain gauges, personal inspection, etc.), current or historical data, predictive data, adjusted data, and the like.

Additionally, although the disclosure generally describes rainfall and flooding, it is noted that other storm events and conditions may also be used and applied to the probable annual risk methods and systems, for example, hurricanes, tornadoes, droughts, wildfires, earthquakes, wind speed, temperature, snow and blizzards, avalanches, storm surge, tsunamis, and the like.

Although the embodiments of the present teachings have been illustrated in the accompanying drawings and described in the foregoing detailed description, it is to be understood that the present teachings are not to be limited to just the embodiments disclosed, but that the present teachings described herein are capable of numerous rearrangements, modifications and substitutions without departing from the scope of the claims hereafter. The claims as follows are intended to include all modifications and alterations insofar as they come within the scope of the claims or the equivalent thereof.

1. A method of assessing flood risk, comprising:
selecting a geographical region;
assigning each asset in the geographical region a condition rating [CR];
assigning each asset in the geographical region a criticality value;
calculating business risk exposure [BRE] as a product of the condition rating [CR] and the criticality for each asset;
calculating risk [RISK] by subtracting an acceptable level of risk [ALR] value from the business risk exposure [BRE];
selecting a data set and a climate condition to establish a probable annual frequency [PAF] of a selected storm in the geographical region; and
calculating a probable annual risk [PAR] by multiplying the risk [RISK] by the probable annual frequency [PAF].

2. The method of claim 1, wherein the condition rating for each asset indicates a maximum permissible inundation depth of rainfall before the asset becomes compromised as impassable, inaccessible, or damaged.

3. The method of claim 2, wherein the maximum permissible inundation depth of rainfall is a value between 0 to 50 inches above a freeboard depth of the asset.

4. The method of claim 2, wherein the condition rating is a value from 1 to 5, wherein the higher the condition rating, the lower the maximum permissible inundation depth of rainfall before the asset becomes compromised as impassable, inaccessible, or damaged.

5. The method of claim 1, wherein the condition rating for each asset indicates a current physical condition of the asset, wherein the current physical condition is defined as status of the asset, age of the asset, or life expectancy remaining of the asset before maintenance, repair, or replacement.

6. The method of claim 4, wherein the condition rating is a value from 1 to 5, wherein the higher the condition rating, the worse the current physical condition of the asset.

7. The method of claim 1, wherein the criticality value for each asset is based on a type of the asset, wherein hospitals and critical roadways are evaluated at a higher criticality than non-essential assets, assets having less financial impact, population or traffic, or recreational assets.

8. The method of claim 1, wherein the criticality value is a value from 1 to 9, wherein the higher the criticality value, the more critical and priority of the asset.

9. The method of claim 1, wherein the acceptable level of risk [ALR] value is 0 to 100.

10. The method of claim 1, wherein a positive value for [RISK] is an unacceptable risk level and wherein a zero or negative value for [RISK] is an acceptable risk level.

11. The method of claim 1, wherein the [RISK] does not change based on the probable annual frequency [PAF].

12. The method of claim 1, wherein the probable annual [PAF] is based on NOAA Atlas-14 values data sets for selected duration, depth, and time value(s).

13. The method of claim 12, wherein the selected duration value(s) is chosen from one or more of: a 6 month storm, a 1 year storm, a 2 year storm, a 5 year storm, a 10 year storm, a 100 year storm, a 500 year storm, or a 1,000 year storm.

14. The method of claim 13, wherein the probable annual [PAF] is an inverse of the selected duration value(s).

15. The method of claim 12, wherein the selected depth value(s) is chosen from one or more of: less than 1 inch, 1 inch, 2, inches, 3 inches, 4 inches, 5 inches, 6 inches, 7 inches, or greater than 7 inches.

16. The method of claim 12, wherein the selected time value(s) is chosen from one or more of: less than 6 hours, 6 hours, 12 hours, 24 hours, 36 hours, 48 hours, or greater than 48 hours.

17. The method of claim 12, wherein the probable annual frequency [PAF] is modified by a percentage value increase or decrease.

18. The method of claim 12, wherein the probable annual frequency [PAF] is modified by a probability distribution factor.

19. The method of claim 18, wherein the probability distribution factor is chosen from one or more of: a uniform distribution, a Huff distribution including each quarter thereof, or a Soil Conservation Service (SCS) distribution including Types I, IA, II, and III.

20. The method of claim 1 further comprising calculating reduced probable annual risk [PARR] by subtracting post-project calculations from pre-project calculations of probable annual risk [PAR].
